(19) United States
(12) Patent Application Publication
(10) Pub. No.: US 2024/0323771 A1
(43) Pub. Date: Sep. 26, 2024

(54) WIRELESS COMMUNICATION METHOD AND APPARATUS

(71) Applicant: HUAWEI TECHNOLOGIES CO., LTD., Shenzhen (CN)

(72) Inventors: Gongzheng ZHANG, Hangzhou (CN); Rong LI, Boulogne Billancourt (FR); Yunfei QIAO, Hangzhou (CN); Jian WANG, Hangzhou (CN)

(73) Assignee: HUAWEI TECHNOLOGIES CO., LTD., Shenzhen (CN)

(21) Appl. No.: 18/732,350

(22) Filed: Jun. 3, 2024

Related U.S. Application Data
(63) Continuation of application No. PCT/CN2022/136586, filed on Dec. 5, 2022.

(30) Foreign Application Priority Data
Dec. 7, 2021 (CN) 202111486570.2

(51) Int. Cl. H04W 36/00

(52) U.S. Cl. CPC H04W 36/0055

(57) ABSTRACT

Embodiments of this application provide a wireless communication method and apparatus. The method includes the following: a terminal device obtains a first model of a first network device. The terminal device receives first model indication information from a second network device. The first model indication information indicates a second model of the second network device. The terminal device sends second model indication information to the second network device. The second model indication information indicates an ensemble model of the first model and the second model. According to the methods provided in this application, the terminal device performs model ensembling, to implement knowledge transfer between network devices, thereby improving performance of a neural network model.

### CROSS-REFERENCE TO RELATED APPLICATIONS

This application is a continuation of International Application No. PCT/CN2022/136586, filed on Dec. 5, 2022, which claims priority to Chinese Patent Application No. 202111486570.2, filed on Dec. 7, 2021. The disclosures of the aforementioned applications are hereby incorporated by reference in their entireties.

### TECHNICAL FIELD

Embodiments of this application relate to the communication field, and more specifically, to a wireless communication method and apparatus.

### BACKGROUND

In a wireless communication network, wireless federated learning can implement joint training of a neural network with a plurality of terminal devices within coverage of a network device through interaction between the terminal devices and the network device, to fully utilize data of the plurality of terminal devices. However, in conventional federated learning, only terminal data of a current cell can be used, and cross-cell federated learning cannot be implemented. In other words, when a terminal device is handed over between cells, a training result of the terminal device within coverage of a source network device cannot be applied to training within coverage of a target network device, thereby affecting performance of a neural network model.

### SUMMARY

This application provides a wireless communication method and apparatus, to implement inter-cell knowledge transfer, thereby improving performance of a neural network model.

According to a first aspect, a wireless communication method is provided. A terminal device obtains a first model of a first network device. The terminal device receives first model indication information from a second network device. The first model indication information indicates a second model of the second network device. The terminal device sends second model indication information to the second network device. The second model indication information indicates an ensemble model of the first model and the second model.

In some embodiments provided in this application, the terminal device performs model ensembling on the first model and the second model, to implement inter-cell knowledge transfer when the terminal device is handed over between cells. In addition, joint training is performed in different cell environments, thereby helping improve performance of a neural network model.

Optionally, that the terminal device obtains the first model of the first network device may be that the terminal device reads the first model of the first network device from a memory of the terminal device, or the terminal device receives the first model from the first network device.

Optionally, that the terminal device receives the first model indication information from the second network device may be as follows:

When the terminal device has not completed handover from the first network device to the second network device, the second network device sends the first model indication information to the first network device, and the first network device forwards the first model indication information to the terminal device: or when the terminal device has completed handover from the first network device to the second network device, the second network device directly sends the first model indication information to the terminal device.

Optionally, that the terminal device sends the second model indication information to the second network device may be as follows:

When the terminal device has not completed handover from the first network device to the second network device, the terminal device sends the second model indication information to the first network device, and the first network device forwards the second model indication information to the second network device; or when the terminal device has completed handover from the first network device to the second network device, the terminal device directly sends the second model indication information to the second network device.

Optionally, a manner in which the terminal device performs model ensembling may be a model ensembling manner used in any one of conventional federated learning, split learning, or knowledge distillation.

With reference to the first aspect, in some implementations of the first aspect, the terminal device is handed over from the first network device to the second network device. In other words, the first network device is a source network device, and the second network device is a target network device.

Optionally, a scenario may be that the network device does not move, and the terminal device moves from coverage of the first network device to coverage of the second network device, or that the terminal device does not move, but the network device moves, so that the terminal device is handed over from the first network device to the second network device.

In some embodiments provided in this application, the terminal device is handed over from the source network device to the target network device, to trigger model ensembling on a terminal device side and prepare neural network models and learning information of the source network device and the target network device.

With reference to the first aspect, in some implementations of the first aspect, the second model indication information includes a model parameter of the ensemble model, and the second model indication information is further used by the second network device to perform model ensembling on the ensemble model and the second model.

A manner in which the second network device performs model ensembling on the ensemble model and the second model may be a model ensembling manner used in any one of conventional federated learning, split learning, and knowledge distillation.

In some embodiments provided in this application, the second network device can perform model ensembling on the ensemble model and the original second model of the second network device, to implement knowledge fusion of the first network device and the second network device and implement inter-cell knowledge transfer, thereby improving performance of a neural network model. In addition, the second network device sends the ensemble model of the terminal device to each terminal device in the coverage of the second network device, so that the terminal device in the coverage of the second network device can update a local model based on the ensemble model, thereby implementing knowledge transfer between terminal devices.

With reference to the first aspect, in some implementations of the first aspect, the terminal device sends third model indication information to the first network device. The third model indication information indicates the ensemble model.

In some embodiments provided in this application, the first network device sends the ensemble model to a terminal device in the coverage of the first network device, so that each terminal device in the coverage of the first network device can update a local model based on the ensemble model and perform model training. This implements knowledge fusion of the first network device and the second network device and inter-cell knowledge transfer, thereby improving performance of a neural network model.

With reference to the first aspect, in some implementations of the first aspect, before the terminal device receives the first model indication information from the second network device, the terminal device sends capability information to the first network device or the second network device. The capability information includes computility and/or storage space of the terminal device.

Before the terminal device receives the first model indication information from the second network device, when the terminal device has not completed handover from the first network device to the second network device, the terminal device sends the capability information to the first network device, and the first network device sends handover request information to the second network device. The handover request information includes the capability information. Alternatively, when the terminal device has completed handover from the first network device to the second network device, the terminal device directly sends the capability information to the second network device.

In some embodiments provided in this application, the terminal device determines, based on the computility and/or the storage space of the terminal device, that the terminal device has a model ensembling capability, so that the terminal device can perform model ensembling, to implement inter-cell knowledge transfer.

With reference to the first aspect, in some implementations of the First aspect, the terminal device receives ensembling indication information from the second network device. The ensembling indication information indicates to the terminal device to perform model ensembling. The ensemble model is obtained by the terminal device by performing model ensembling on the first model and the second model based on the ensembling indication information.

The second network device determines, based on the received capability information, that the terminal device has the model ensembling capability. When the terminal device has not completed handover from the first network device to the second network device, the second network device sends handover request acknowledgment information to the first network device, and the first network device forwards the ensembling indication information to the terminal device. The handover request acknowledgment information includes the ensembling indication information. Alternatively, when the terminal device has completed handover from the first network device to the second network device, the second network device directly sends the ensembling indication information to the terminal device.

In some embodiments provided in this application, the terminal device can perform model ensembling on the first model and the second model based on the received ensembling indication information of the second network device, to implement inter-cell knowledge transfer.

With reference to the first aspect, in some implementations of the first aspect, the first model indication information further includes a model ensembling parameter of the second network device.

When the terminal device has completed handover from the first network device to the second network device, the second network device sends the model ensembling parameter of the second network device to the terminal device, or the second network device sends the first model indication information to the terminal device, where the first model indication information includes the model parameter of the second network device. Alternatively, when the terminal device has not completed handover from the first network device to the second network device, the second network device sends the handover request acknowledgment information to the first network device, and the first network device sends the model ensembling parameter of the second network device to the terminal device, where the handover request acknowledgment information includes the model ensembling parameter of the second network device.

The model ensembling parameter of the second network device is a parameter used when the second network device performs model ensembling on a local model reported by a terminal device in the coverage of the second network device, before the second network device receives an ensemble model on a terminal device side. The model ensembling parameter includes one or more of a quantity of model ensembling rounds, a data volume, a learning rate, or an optimizer.

In some embodiments provided in this application, the terminal device may adjust, based on the received model ensembling parameter of the second network device, a parameter for performing model ensembling on the first model and the second model by the terminal device, to determine an appropriate model ensembling parameter, thereby improving accuracy of a neural network model.

With reference to the first aspect, in some implementations of the first aspect, the ensemble model is obtained by the terminal device by performing model ensembling on the first model and the second model when an artificial intelligence (AI) area corresponding to the first network device is the same as an AI area corresponding to the second network device.

If the terminal device moves to a different AI area, that is, when the AI area corresponding to the first network device is different from the AI area corresponding to the second network device, the terminal device buffers a neural network model of the first network device, and performs model ensembling when being handed over to the same AI area of the first network device.

In some embodiments provided in this application, model ensembling on a terminal device side is triggered when the first network device and the second network device belong to a same AI area, so that model sharing and joint training of a plurality of cells in the same AI area can be supported, to implement inter-cell knowledge transfer.

With reference to the first aspect, in some implementations of the first aspect, the AI area is determined based on one or more pieces of the following information: an environment similarity, a data similarity, an AI task, or a model version.

In some embodiments provided in this application, the AI area is configured based on one or more of: the environment similarity, the data similarity, the AI task, or the model version. The AI area is identified by using an AI area identifier. The AI area identifier may be an AI area ID, an AI area code, an AI area address, or the like. Optionally, the AI area may be independently configured based on each AI task, that is, each AI task corresponds to one AI area identifier. Alternatively, the AI area may be configured in a nested manner based on the AI task. In other words, hierarchical AI areas are formed based on a plurality of AI tasks, and each level of AI area corresponds to some fields in one AI area identifier.

In some embodiments provided in this application, cells in the same AI area may use a same neural network model, or may participate in joint training, thereby improving accuracy of the neural network model. When the terminal device is handed over between cells in the AI area, a new model does not need to be downloaded, thereby reducing interaction overhead.

With reference to the first aspect, in some implementations of the first aspect, the terminal device obtains an AI area identifier of the first network device and/or an AI area identifier of the second network device.

A third network device sends the corresponding AI area identifier of the first network device and/or the corresponding AI area identifier of the second network device to the first network device and/or the second network device. The first network device sends the corresponding AI area identifier of the first network device to the terminal device. When the terminal device has not completed handover from the first network device to the second network device, the second network device sends the corresponding AI area identifier of the second network device to the first network device, and the first network device forwards the corresponding AI area identifier of the second network device to the terminal device. Alternatively, when the terminal device has completed handover from the first network device to the second network device, the second network device directly sends the corresponding AI area identifier of the second network device to the terminal device. The first network device and the second network device each may send the AI area identifier to the terminal device by using radio resource control (RRC) signaling, a media access control element (MAC CE), a broadcast message, or the like.

In some embodiments provided in this application, the terminal device can store AI area information of the first network device and/or the second network device, and update the AI area when the terminal device is handed over between cells. In addition, when the terminal device is handed over between cells, and the first network device and the second network device belong to the same AI area, model ensembling on a terminal device side can be triggered, to implement inter-cell knowledge transfer.

With reference to the first aspect, in some implementations of the first aspect, the terminal device receives AI configuration information from the third network device. The AI configuration information includes AI operation indication information and one or more of the following: a model parameter, a data type, or a data processing type. The AI operation indication information includes the AI area identifier. The AI operation indication information indicates an AI operation corresponding to the terminal device. The AI operation includes one or more of: model inference, model evaluation, model training, or data processing.

The third network device sends the AI configuration information to the first network device and/or the second network device. When the terminal device has not completed handover from the first network device to the second network device, the first network device sends the AI configuration information to the terminal device. When the terminal device has completed handover from the first network device to the second network device, the second network device sends the AI configuration information to the terminal device. The first network device or the second network device sends the AI configuration information to the terminal device. A manner in which the first network device or the second network device sends the AI configuration information to the terminal device may be transparent transmission.

Optionally, the AI operation indication information may be separately sent by the third network device to the first network device and/or the second network device, and the first network device or the second network device sends the AI operation indication information to the terminal device. The AI operation indication information may be transmitted to the terminal device through a physical downlink control channel (PDCCH), and is scrambled by using a radio network temporary identifier (RNTI) related to an AI task, to indicate an AI operation resource, for example, a time-frequency resource.

When the AI area to which the terminal device belongs matches the AI area identifier carried in the AI operation indication information, the terminal device performs the AI operation.

In some embodiments provided in this application, an AI operation may be triggered based on an AI area, to support joint training of a plurality of cells.

According to a second aspect, a wireless communication method is provided. A second network device sends first model indication information to a terminal device. The first model indication information indicates a second model of the second network device. The second network device receives second model indication information from the terminal device. The second model indication information indicates an ensemble model of a first model and the second model. The first model is a model that is of a first network device and that is obtained by the terminal device.

Optionally, that the second network device sends the first model indication information to the terminal device may be as follows: When the terminal device has not completed handover from the first network device to the second network device, the second network device sends the first model indication information to the first network device, and the first network device forwards the first model indication information to the terminal device: or when the terminal device has completed handover from the first network device to the second network device, the second network device directly sends the first model indication information to the terminal device.

Optionally, that the second network device receives the second model indication information from the terminal device may be as follows: When the terminal device has not completed handover from the first network device to the second network device, the terminal device sends the second model indication information to the first network device, and the first network device forwards the second model indication information to the second network device; or when the terminal device has completed handover from the first network device to the second network device, the terminal device directly sends the second model indication information to the second network device.

Optionally, that the terminal device obtains the first model of the first network device may be that the terminal device reads the first model of the first network device from a memory of the terminal device, or the terminal device receives the first model from the first network device.

In some embodiments provided in this application, the terminal device performs model ensembling on the first model and the second model, to implement inter-cell knowledge transfer when the terminal device is handed over between cells. In addition, joint training is performed in different cell environments, thereby improving performance of a neural network model.

With reference to the second aspect, in some implementations of the second aspect, the second network device is a target network device to which the terminal device is handed over.

In some embodiments provided in this application, the terminal device is handed over from a source network device to the target network device, to trigger model ensembling on a terminal device side and prepare neural network models and learning information of the source network device and the target network device.

With reference to the second aspect, in some implementations of the second aspect, the second model indication information includes a model parameter of the ensemble model, and the second model indication information is further used by the second network device to perform model ensembling on the ensemble model and the second model.

A manner in which the second network device performs model ensembling on the ensemble model and the second model may be a model ensembling manner used in any one of conventional federated learning, split learning, and knowledge distillation.

In some embodiments provided in this application, the second network device can perform model ensembling on the ensemble model and the original second model of the second network device, to implement knowledge fusion of the first network device and the second network device and implement inter-cell knowledge transfer, thereby improving performance of a neural network model. In addition, the second network device can send the ensemble model of the terminal device to a terminal device in coverage of the second network device, so that the terminal device in the coverage of the second network device updates a local model based on the ensemble model, thereby implementing knowledge transfer between terminal devices.

With reference to the second aspect, in some implementations of the second aspect, the second network device sends fourth model indication information to the first network device, where the fourth model indication information indicates the ensemble model, or the second network device sends fifth model indication information to a third network device, where the fifth model indication information indicates to the third network device to send the ensemble model to the first network device.

In some embodiments provided in this application, the second network device sends the ensemble model to the first network device, or the third network device receives the ensemble model sent by the second network device, and forwards the ensemble model to the first network device. This replaces a case in which the terminal device sends the ensemble model to the first network device, to avoid maintenance of dual connections of the terminal device to the first network device and the second network device, thereby saving air interface resources.

With reference to the second aspect, in some implementations of the second aspect, before the second network device sends the first model indication information to the terminal device, the second network device receives handover request information from the first network device, where the handover request information includes capability information; or the second network device receives capability information from the terminal device, where the capability information includes computility and/or storage space of the terminal device.

Before the terminal device receives the first model indication information from the second network device, when the terminal device has not completed handover from the first network device to the second network device, the second network device receives the handover request information from the first network device, where the handover request information includes the capability information, and the capability information is sent by the terminal device to the first network device; or when the terminal device has completed handover from the first network device to the second network device, the second network device directly receives the capability information from the terminal device.

In some embodiments provided in this application, the terminal device determines, based on the computility and/or the storage space of the terminal device, that the terminal device has a model ensembling capability, so that the terminal device can perform model ensembling, to implement inter-cell knowledge transfer.

With reference to the second aspect, in some implementations of the second aspect, the second network device determines, based on the capability information, that the terminal device has the model ensembling capability. The second network device sends handover request acknowledgment information to the first network device. The handover request acknowledgment information includes ensembling indication information. The ensembling indication information indicates to the terminal device to perform model ensembling. Alternatively, the second network device sends ensembling indication information to the terminal device. The ensembling indication information indicates to the terminal device to perform model ensembling. The ensemble model is obtained by the terminal device by performing model ensembling on the first model and the second model based on the ensembling indication information.

When the terminal device has not completed handover from the first network device to the second network device, the second network device sends the handover request acknowledgment information to the first network device, and the first network device forwards the ensembling indication information to the terminal device. The handover request acknowledgment information includes the ensembling indication information. Alternatively, when the terminal device has completed handover from the first network device to the second network device, the second network device directly sends the ensembling indication information to the terminal device.

In some embodiments provided in this application, the terminal device can perform model ensembling on the first model and the second model based on the received ensembling indication information from the second network device, to implement inter-cell knowledge transfer.

With reference to the second aspect, in some implementations of the second aspect, the first model indication information further includes a model ensembling parameter of the second network device.

When the terminal device has completed handover from the first network device to the second network device, the second network device sends the model ensembling parameter of the second network device to the terminal device, or the second network device sends the first model indication information to the terminal device, where the first model indication information includes the model parameter of the second network device. Alternatively, when the terminal device has not completed handover from the first network device to the second network device, the second network device sends the handover request acknowledgment information to the first network device, and the first network device sends the model ensembling parameter of the second network device to the terminal device, where the handover request acknowledgment information includes the model ensembling parameter of the second network device.

The model ensembling parameter of the second network device is a parameter used when the second network device performs model ensembling on the local model reported by the terminal device in the coverage of the second network device, before the second network device receives the ensemble model on the terminal device side, for example, a quantity of model ensembling rounds, a data volume, a learning rate, and an optimizer.

In some embodiments provided in this application, the terminal device may adjust, based on the received model ensembling parameter of the second network device, a parameter for performing model ensembling on the first model and the second model by the terminal device, to determine an appropriate model ensembling parameter, thereby improving accuracy of a neural network model.

With reference to the second aspect, in some implementations of the second aspect, the second network device sends a corresponding AI area identifier of the second network device to the terminal device.

The third network device sends the corresponding AI area identifier of the second network device to the second network device. When the terminal device has not completed handover from the first network device to the second network device, the second network device sends the corresponding AI area identifier of the second network device to the first network device, and the first network device forwards the corresponding AI area identifier of the second network device to the terminal device. Alternatively, when the terminal device has completed handover from the first network device to the second network device, the second network device directly sends the corresponding AI area identifier of the second network device to the terminal device. The first network device and the second network device each may send the AI area identifier to the terminal device by using RRC signaling, MAC CE signaling, or a broadcast message.

In some embodiments provided in this application, the terminal device can store an AI area identifier of the first network device and/or the AI area identifier of the second network device, and update an AI area when the terminal device is handed over between cells. In addition, when the terminal device is handed over between cells, and the first network device and the second network device belong to the same AI area, model ensembling on a terminal device side can be triggered, to implement inter-cell knowledge transfer.

With reference to the second aspect, in some implementations of the second aspect, the AI area identifier is determined based on one or more pieces of the following information: an environment similarity, a data similarity, an AI task, or a model version.

In some embodiments provided in this application, the AI area is configured based on one or more of: the environment similarity, the data similarity, the AI task, or the model version, and the AI area is identified by using an AI area ID, an AI area code, an AI area address, or the like. Optionally, the AI area may be independently configured based on each AI task, that is, each AI task corresponds to one AI area identifier. Alternatively, the AI area identifier may be configured in a nested manner based on the AI task. In other words, hierarchical AI areas are formed based on a plurality of AI tasks, and each level of AI area corresponds to some fields in one AI area identifier.

In some embodiments provided in this application, cells in the same AI area may use a same neural network model, or may participate in joint training, thereby improving accuracy of the neural network model. In addition, the AI area may include a plurality of cells whose geographical locations are not adjacent. When the terminal device is handed over between cells in the AI area, a new model does not need to be downloaded, thereby reducing interaction overhead.

With reference to the second aspect, in some implementations of the second aspect, the second network device receives AI configuration information from the third network device. The AI configuration information includes AI operation indication information and one or more of the following: a model parameter, a data type, or a data processing type. The AI operation indication information includes the AI area identifier. The AI operation indication information indicates an AI operation corresponding to the terminal device and/or the second network device. The AI operation includes one or more of: model inference, model evaluation, model training, or data processing.

The third network device sends the AI configuration information to the first network device and/or the second network device. When the terminal device has not completed handover from the first network device to the second network device, the first network device sends the AI configuration information to the terminal device. When the terminal device has completed handover from the first network device to the second network device, the second network device sends the AI configuration information to the terminal device. The AI operation indication information may be transmitted through a PDCCH, and is scrambled by using an RNTI related to the AI task, to indicate an AI operation resource, for example, a time-frequency resource.

Optionally, the AI operation indication information may be alternatively separately sent by the third network device to the first network device and/or the second network device.

When the AI area to which the terminal device belongs matches the AI area identifier carried in the AI operation indication information, the terminal device performs the AI operation.

In some embodiments provided in this application, an AI operation may be triggered based on an AI area, to support joint training of a plurality of cells.

According to a third aspect, a wireless communication method is provided. A second network device obtains a second model of the second network device. The second network device receives sixth model indication information from a first network device or a terminal device. The sixth model indication information indicates a first model of the first network device. The second network device performs model ensembling on the first model and the second model. The second network device sends seventh model indication information to the first network device. The seventh model indication information indicates an ensemble model of the first model and the second model.

When the terminal device has not completed handover from the first network device to the second network device, the second network device receives the sixth model indication information sent by the first network device; or when the terminal device has completed handover from the first network device to the second network device, the second network device receives the sixth model indication information sent by the terminal device.

A manner in which the second network device performs model ensembling on the first model and the second model may be a model ensembling manner used in any one of conventional federated learning, split learning, and knowledge distillation.

In some embodiments provided in this application, the second network device performs model ensembling on the first model of the first network device and the second model of the second network device, to implement inter-cell knowledge transfer, thereby improving performance of a neural network model.

With reference to the third aspect, in some implementations of the third aspect, the sixth model indication information includes a model ensembling parameter of the first network device.

The model ensembling parameter of the first network device may be alternatively separately sent by the first network device to the second network device. The model ensembling parameter of the first network device is a parameter used when the first network device performs model ensembling on a local model reported by a terminal device in coverage of the first network device before the first network device receives an ensemble model of the second network device. The model ensembling parameter includes one or more of: a quantity of model ensembling rounds, a data volume, a learning rate, or an optimizer.

In some embodiments provided in this application, the second network device may adjust, based on the received model ensembling parameter of the first network device, a parameter for performing model ensembling on the first model and the second model by the second network device, to determine an appropriate model ensembling parameter, thereby improving accuracy of a neural network model.

With reference to the third aspect, in some implementations of the third aspect, the ensemble model is obtained by the second network device by performing model ensembling on the first model and the second model when an AI area corresponding to the second network device is the same as an AI area corresponding to the first network device.

If the terminal device moves to a different AI area, the terminal device buffers a neural network model of a source network device. The second network device performs model ensembling when the terminal device is handed over to the same AI area of the first network device.

In some embodiments provided in this application, model ensembling on a terminal device side is triggered when the first network device and the second network device belong to a same AI area so that model sharing and joint training of a plurality of cells in the same AI area can be supported, to implement inter-cell knowledge transfer.

With reference to the third aspect, in some implementations of the third aspect, the AI area is determined based on one or more pieces of the following information: an environment similarity, a data similarity, an AI task, or a model version.

In some embodiments provided in this application, the AI area is configured based on one or more of: the environment similarity, the data similarity, the AI task, or the model version, and the AI area is identified by using an AI area ID, an AI area code, an AI area address, or the like. Optionally, the AI area may be independently configured based on each AI task, that is, each AI task corresponds to one AI area identifier. Alternatively, the AI area identifier may be configured in a nested manner based on the AI task. In other words, hierarchical AI areas are formed based on a plurality of AI tasks, and each level of AI area corresponds to some fields in one AI area identifier.

In some embodiments provided in this application, cells in the same AI area may use a same neural network model, or may participate in joint training, thereby improving accuracy of the model. In addition, the AI area may include a plurality of cells whose geographical locations are not adjacent. When the terminal device is handed over between cells in the AI area, a new model does not need to be downloaded, thereby reducing interaction overhead.

With reference to the third aspect, in some implementations of the third aspect, the second network device obtains AI area identifiers of the second network device and the first network device.

A third network device sends the corresponding AI area identifier of the first network device and/or the corresponding AI area identifier of the second network device to the first network device and/or the second network device. The first network device sends a corresponding AI area identifier of the terminal device to the second network device. Alternatively, when the terminal device has completed handover from the first network device to the second network device, the terminal device sends the AI area identifier of the terminal device to the second network device.

In some embodiments provided in this application, the terminal device can store the AI area identifier of the first network device and/or the AI area identifier of the second network device, and update the AI area identifier when the terminal device is handed over between cells. In addition, when the terminal device is handed over between cells, and the first network device and the second network device belong to the same AI area, model ensembling on a second network device side can be triggered, to implement inter-cell knowledge transfer.

With reference to the third aspect, in some implementations of the third aspect, the second network device receives AI configuration information from the third network device. The AI configuration information includes AI operation indication information and one or more of the following: a model parameter, a data type, or a data processing type. The AI operation indication information includes the AI area identifier. The AI operation indication information indicates an AI operation corresponding to the second network device. The AI operation includes one or more of: model inference, model evaluation, model training, or data processing.

Optionally, the AI operation indication information may be alternatively separately sent by the third network device to the first network device and/or the second network device.

When an AI area to which the second network device belongs matches the AI area identifier carried in the AI operation indication information, the second network device performs the AI operation.

In some embodiments provided in this application, an AI operation may be triggered based on an AI area, to support joint training of a plurality of cells.

According to a fourth aspect, a wireless communication method is provided. A third network device receives fifth model indication information from a second network device. The fifth model indication information indicates to the third network device to send an ensemble model of a first model and a second model to a first network device. The first model is a model obtained by a terminal device in coverage of the first network device. The second model is a model of the second network device. The third network device sends eighth model indication information to the first network device. The eighth model indication information indicates the ensemble model.

In some embodiments provided in this application, the third network device sends the ensemble model of the first model and the second model to the first network device. This replaces a case in which the terminal device sends the ensemble model to the first network device, to avoid maintenance of dual connections of the terminal device to the first network device and the second network device, thereby saving air interface resources.

With reference to the fourth aspect, in some implementations of the fourth aspect, the third network device determines an AI area identifier based on one or more of: an environment similarity, a data similarity, an AI task, or a model version. The third network device sends the AI area identifier to the first network device and the second network device.

In some embodiments provided in this application, the third network device configures an AI area based on one or more of: the environment similarity, the data similarity, the AI task, or the model version, and the AI area is identified by using an AI area ID, an AI area code, an AI area address, or the like. Optionally, the AI area may be independently configured based on each AI task, that is, each AI task corresponds to one AI area identifier. Alternatively, the AI area identifier may be configured in a nested manner based on the AI task. In other words, hierarchical AI areas are formed based on a plurality of AI tasks, and each level of AI area corresponds to some fields in one AI area identifier.

In some embodiments provided in this application, cells in the same AI area may use a same neural network model, or may participate in joint training, thereby improving accuracy of the model. In addition, the AI area may include a plurality of cells whose geographical locations are not adjacent. When the terminal device is handed over between cells in the AI area, a new model does not need to be downloaded, thereby reducing interaction overhead.

With reference to the fourth aspect, in some implementations of the fourth aspect, the third network device sends AI configuration information to the first network device and/or the second network device. The AI configuration information includes AI operation indication information and one or more of the following: a model parameter, a data type, or a data processing type. The AI operation indication information includes the AI area identifier. The AI operation indication information indicates an AI operation corresponding to the first network device and/or the second network device. The AI operation includes one or more of: model inference, model evaluation, model training, or data processing.

The third network device sends the AI configuration information to the first network device and/or the second network device. When the terminal device has not completed handover from the first network device to the second network device, the first network device sends the AI configuration information to the terminal device. When the terminal device has completed handover from the first network device to the second network device, the second network device sends the AI configuration information to the terminal device.

Optionally, the AI operation indication information may also be separately sent by the third network device to the first network device and/or the second network device, and the first network device or the second network device sends the AI operation indication information to the terminal device. The AI operation indication information may be transmitted through a PDCCH, and is scrambled by using an RNTI related to an AI task, to indicate an AI operation resource, for example, a time-frequency resource.

When an AI area to which the first network device and/or the second network device belong/belongs matches the AI area identifier carried in the AI operation indication information, the first network device and/or the second network device performs the AI operation.

In some embodiments provided in this application, an AI operation may be triggered based on an AI area, to support joint training of a plurality of cells.

According to a fifth aspect, a communication apparatus is provided. The apparatus includes a unit for performing the method in any implementation of the first aspect. The apparatus may include a processing unit and a transceiver unit. The processing unit is configured to obtain, a first model of a first network device. The transceiver unit is configured to receive, by the terminal device, first model indication information from a second network device. The first model indication information indicates a second model of the second network device. The transceiver unit is further configured to send, by terminal device, second model indication information to the second network device. The second model indication information indicates an ensemble model of the first model and the second model.

With reference to the fifth aspect, in some implementations of the fifth aspect, the terminal device is handed over from the first network device to the second network device.

With reference to the fifth aspect, in some implementations of the fifth aspect, the second model indication information includes a model parameter of the ensemble model, and the second model indication information is further used by the second network device to perform model ensembling on the ensemble model and the second model.

With reference to the fifth aspect, in some implementations of the fifth aspect, the transceiver unit is further configured to send, by the terminal device, third model indication information to the first network device. The third model indication information indicates the ensemble model.

With reference to the fifth aspect, in some implementations of the fifth aspect, before the terminal device receives the first model indication information from the second network device, the transceiver unit is further configured to send, by the terminal device, capability information to the first network device or the second network device. The capability information includes computility and/or storage space of the terminal device.

With reference to the fifth aspect, in some implementations of the fifth aspect, the transceiver unit is further configured to receive, by the terminal device, ensembling indication information from the second network device. The ensembling indication information indicates to the terminal device to perform model ensembling. The ensemble model is obtained by the terminal device by performing model ensembling on the first model and the second model based on the ensembling indication information.

With reference to the fifth aspect, in some implementations of the fifth aspect, the first model indication information further includes a model ensembling parameter of the second network device.

With reference to the fifth aspect, in some implementations of the fifth aspect, the ensemble model is obtained by the terminal device by performing model ensembling on the first model and the second model when an AI area corresponding to the first network device is the same as an AI area corresponding to the second network device.

With reference to the fifth aspect, in some implementations of the fifth aspect, the AI area is determined based on one or more pieces of the following information: an environment similarity, a data similarity, an AI task, or a model version.

With reference to the fifth aspect, in some implementations of the fifth aspect, the processing unit is further configured to obtain, by the terminal device, an AI area identifier of the first network device and/or an AI area identifier of the second network device.

With reference to the fifth aspect, in some implementations of the fifth aspect, the transceiver unit is further configured to receive, by the terminal device, AI configuration information from the third network device. The AI configuration information includes AI operation indication information and one or more of the following: a model parameter, a data type, or a data processing type. The AI operation indication information includes the AI area identifier. The AI operation indication information indicates an AI operation corresponding to the terminal device. The AI operation includes one or more of: model inference, model evaluation, model training, or data processing.

According to a sixth aspect, a communication apparatus is provided. The apparatus includes a unit for performing the method in any implementation of the second aspect. The apparatus may include a processing unit and a transceiver unit. The transceiver unit is configured to send first model indication information to a terminal device. The first model indication information indicates a second model of the second network device. The transceiver unit is further configured to receive, by the second network device, second model indication information from the terminal device. The second model indication information indicates an ensemble model of a first model and the second model. The first model is a model that is of a first network device and that is obtained by the terminal device.

With reference to the sixth aspect, in some implementations of the sixth aspect, the second network device is a target network device to which the terminal device is handed over.

With reference to the sixth aspect, in some implementations of the sixth aspect, the second model indication information includes a model parameter of the ensemble model, and the second model indication information is further used by the second network device to perform model ensembling on the ensemble model and the second model.

With reference to the sixth aspect, in some implementations of the sixth aspect, the transceiver unit is further configured to send, by the second network device, fourth model indication information to the first network device, where the fourth model indication information indicates the ensemble model, or the transceiver unit is further configured to send, by the second network device, fifth model indication information to a third network device, where the fifth model indication information indicates to the third network device to send the ensemble model to the first network device.

With reference to the sixth aspect, in some implementations of the sixth aspect, before the second network device sends the first model indication information to the terminal device, the transceiver unit is further configured to receive, by the second network device, handover request information from the first network device, where the handover request information includes capability information; or the transceiver unit is further configured to receive, by the second network device, capability information from the terminal device, where the capability information includes computility and/or storage space of the terminal device.

With reference to the sixth aspect, in some implementations of the sixth aspect, the processing unit is configured to determine, by the second network device based on the capability information, that the terminal device has the model ensembling capability. The transceiver unit is further configured to send, by the second network device, handover request acknowledgment information to the first network device. The handover request acknowledgment information includes ensembling indication information. The ensembling indication information indicates to the terminal device to perform model ensembling. Alternatively, the transceiver unit is further configured to send, by the second network device, ensembling indication information to the terminal device. The ensembling indication information indicates to the terminal device to perform model ensembling. The ensemble model is obtained by the terminal device by performing model ensembling on the first model and the second model based on the ensembling indication information.

With reference to the sixth aspect, in some implementations of the sixth aspect, the first model indication information further includes a model ensembling parameter of the second network device.

With reference to the sixth aspect, in some implementations of the sixth aspect, the AI area identifier is determined based on one or more pieces of the following information: an environment similarity, a data similarity, an AI task, or a model version.

With reference to the sixth aspect, in some implementations of the sixth aspect, the transceiver unit is further configured to send, by the second network device, a corresponding AI area identifier of the second network device to the terminal device.

With reference to the sixth aspect, in some implementations of the sixth aspect, the transceiver unit is further configured to receive, by the second network device, AI configuration information from the third network device. The AI configuration information includes AI operation indication information and one or more of the following: a model parameter, a data type, or a data processing type. The AI operation indication information includes the AI area identifier. The AI operation indication information indicates an AI operation corresponding to the terminal device and/or the second network device. The AI operation includes one or more of: model inference, model evaluation, model training, or data processing.

According to a seventh aspect, a communication apparatus is provided. The apparatus includes a unit for performing the method in any implementation of the third aspect. The apparatus may include a processing unit and a transceiver unit. The processing unit is configured to obtain, by a second network device, a second model of the second network device. The transceiver unit is configured to receive, by the second network device, sixth model indication information from a first network device or a terminal device. The sixth model indication information indicates a first model of the first network device. The transceiver unit is further configured to send, by the second network device, seventh model indication information to the first network device. The seventh model indication information indicates an ensemble model of the first model and the second model.

With reference to the seventh aspect, in some implementations of the seventh aspect, the sixth model indication information includes a model ensembling parameter of the first network device.

With reference to the seventh aspect, in some implementations of the seventh aspect, the ensemble model is obtained by the second network device by performing model ensembling on the first model and the second model when an AI area corresponding to the second network device is the same as an AI area corresponding to the first network device.

With reference to the seventh aspect, in some implementations of the seventh aspect, the AI area is determined based on one or more pieces of the following information: an environment similarity, a data similarity, an AI task, or a model version.

With reference to the seventh aspect, in some implementations of the seventh aspect, the processing unit is further configured to obtain, by the second network device. AI area identifiers of the second network device and the first network device.

With reference to the seventh aspect, in some implementations of the seventh aspect, the transceiver unit is further configured to receive, by the second network device, AI configuration information from a third network device. The AI configuration information includes AI operation indication information and one or more of the following: a model parameter, a data type, or a data processing type. The AI operation indication information includes the AI area identifier. The AI operation indication information indicates an AI operation corresponding to the second network device. The AI operation includes one or more of: model inference, model evaluation, model training, or data processing.

According to an eighth aspect, a communication apparatus is provided. The apparatus includes a unit for performing the method in any implementation of the fourth aspect. The apparatus may include a transceiver unit and a processing unit. The transceiver unit is configured to receive, by a third network device, fifth model indication information from a second network device. The fifth model indication information indicates to the third network device to send an ensemble model of a first model and a second model to a first network device. The first model is a model obtained by a terminal device in coverage of the first network device. The second model is a model of the second network device. The transceiver unit is further configured to send, by the third network device, eighth model indication information to the first network device. The eighth model indication information indicates the ensemble model.

With reference to the eighth aspect, in some implementations of the eighth aspect, the processing unit is configured to determine, by the third network device, an AI area based on one or more of: an environment similarity, a data similarity, an AI task, or a model version. The transceiver unit is further configured to send, by the third network device, an AI area identifier to the first network device and the second network device.

With reference to the eighth aspect, in some implementations of the eighth aspect, the transceiver unit is further configured to send, by the third network device, AI configuration information to the first network device and/or the second network device. The AI configuration information includes AI operation indication information and one or more of the following: a model parameter, a data type, or a data processing type. The AI operation indication information includes the AI area identifier. The AI operation indication information indicates an AI operation corresponding to the first network device and/or the second network device. The AI operation includes one or more of: model inference, model evaluation, model training, or data processing.

According to a ninth aspect, a wireless communication system is provided. The system includes the apparatus in the fifth aspect or any possible implementation of the fifth aspect, the apparatus in the sixth aspect or any possible implementation of the sixth aspect, the apparatus in the seventh aspect or any possible implementation of the seventh aspect, and the apparatus in the eighth aspect or any possible implementation of the eighth aspect.

According to a tenth aspect, a computer program product is provided. The computer program product includes a computer program or a group of instructions. When the computer program or the group of instructions is/are run by a computer, the methods in the foregoing aspects are performed.

According to an eleventh aspect, a computer-readable medium is provided, configured to store a computer program. The computer program includes instructions used to perform the method according to the foregoing aspects.

According to a twelfth aspect, a chip is provided, including a processor. The processor is configured to: invoke instructions in a memory, and run the instructions stored in the memory, to enable a communication device on which the chip is installed to perform the methods in the foregoing aspects.

In a possible implementation, the processor and the memory are integrated.

In another possible implementation, the memory is located outside the communication apparatus.

The communication apparatus further includes a communication interface. The communication interface is used for communication between the communication apparatus and another device, for example, for sending or receiving data and/or a signal. For example, the communication interface may be a transceiver, a circuit, a bus, a module, or another type of communication interface.

According to a thirteenth aspect, some embodiments of this application further provide a communication apparatus, configured to perform the method in the first aspect and the possible implementations of the first aspect.

According to a fourteenth aspect, some embodiments of this application further provide a communication apparatus, configured to perform the method in the second aspect and the possible implementations of the second aspect.

### BRIEF DESCRIPTION OF DRAWINGS

FIG. 1 is a schematic diagram of federated Teaming;

FIG. 2 is a schematic diagram of a fully connected neural network;

FIG. 3 is a schematic diagram of a loss function optimization method in neural network training;

FIG. 4 is a schematic diagram of gradient back propagation in neural network training;

FIG. 5 is a schematic diagram of a system architecture according to some embodiments of this application:

FIG. 6 is a schematic diagram of an AI area according to some embodiments of this application;

FIG. 7 is a schematic diagram of defining an AI area code based on an AI task according to some embodiments of this application;

FIG. 8 is a schematic diagram of interaction in a wireless communication method according to some embodiments of this application;

FIG. 9 is a schematic diagram of interaction in another wireless communication method according to some embodiments of this application:

FIG. 10 is a schematic diagram of an application scenario according to some embodiments of this application:

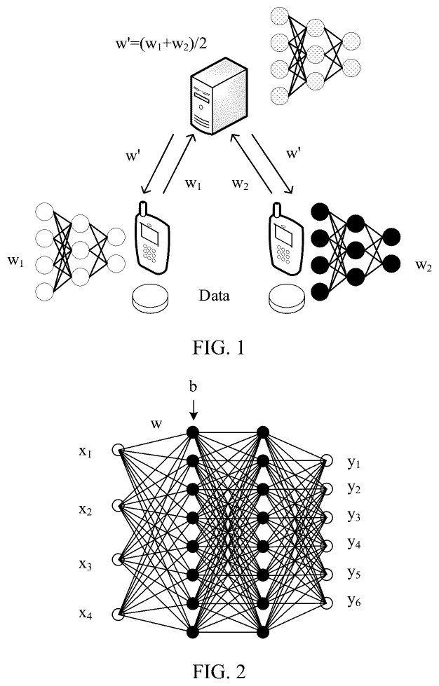

FIG. 1I is a schematic diagram of a handover procedure according to some embodiments of this application:

FIG. 12 is a schematic diagram of interaction in another wireless communication method according to some embodiments of this application;

FIG. 13 is a schematic diagram of interaction in another wireless communication method according to some embodiments of this application:

FIG. 14 is a schematic diagram of an AI operation procedure based on an AI area according to some embodiments of this application;

FIG. 15 is a schematic diagram of a communication apparatus according to some embodiments of this application;

FIG. 16 is a schematic diagram of a communication apparatus according to some embodiments of this application;

FIG. 17 is a schematic diagram of a communication apparatus according to some embodiments of this application; and

FIG. 18 is a schematic diagram of a communication apparatus according to some embodiments of this application.

### DESCRIPTION OF EMBODIMENTS

For ease of understanding of embodiments of this application, related concepts in this application are first briefly described.

1. Federated learning: Federated learning is a distributed learning architecture. FIG. 1 is a schematic diagram of conventional federated learning. A node with data locally performs model training, and uploads a weight or a gradient to a server. The server combines received weights or gradients of a plurality of nodes, and delivers a combined weight or gradient to the node. The node updates a model based on the combined weight. Through federated learning, the node does not upload data to the server, thereby resolving a data privacy problem. In addition, data of each distributed node is fully used, to implement knowledge transfer between nodes.

2. Fully-connected neural network and training method thereof: The fully-connected neural network is also referred to as a multi-layer perceptron (MLP). FIG. 2 is a schematic diagram of a fully-connected neural network. One MLP includes an input layer (as shown on the left side of FIG. 2), an output layer (as shown on the right side of FIG. 2), and a plurality of hidden layers in a middle part. Each layer includes several nodes that are referred to as neurons. Neurons at two adjacent layers are connected to each other.

In the neurons at the two adjacent layers, an output h of a neuron at a next layer is a result obtained according to an activation function based on a weighted result of all neurons x that are at a current layer and that are connected to the neuron at the next layer. This is shown in Formula (1.1):

$$h = f ( w x + b ) \qquad ( 1.1 )$$

Herein, w is a weight matrix, b is a bias vector, and f is an activation function. An output of the neural network may be recursively expressed by using Formula (1.2):

$$y = {f}_{n} ( {w}_{n} {f}_{n - 1} ( … ) + {b}_{n} ) \qquad ( 1.2 )$$

The neural network may be understood as a mapping relationship from an input data set to an output data set. Generally, the neural network is randomly initialized. A process of obtaining the mapping relationship based on random w and b and existing data is referred to as training of the neural network.

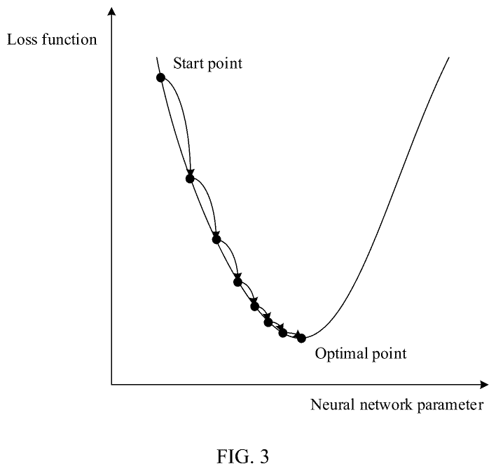

An example training manner is as follows: An output result of the neural network is evaluated by using a loss function, back propagation is performed on an error, w and b are iteratively optimized by using a gradient descent method until the loss function reaches a minimum value. FIG. 3 is a schematic diagram of loss function optimization.

A gradient descent process may be expressed by using Formula (1.3):

$$θ ← θ - η \frac{\partial L}{\partial θ} \qquad ( 1.3 )$$

Herein, θ is a to-be-optimized parameter (for example, w and b), L is the loss function, and η is a learning rate, to control a gradient descent step.

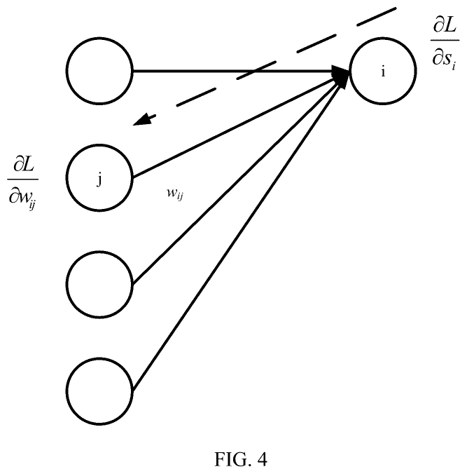

A back propagation process uses a chain rule of obtaining a partial derivative. A previous-layer parameter gradient can be obtained through recursive calculation based on a current-layer parameter gradient. As shown in FIG. 4, this may be expressed by using Formula (1.4):

$$\frac{\partial L}{\partial {w}_{ij}} = \frac{\partial L}{\partial {s}_{i}} \frac{\partial {s}_{i}}{\partial {w}_{ij}} \qquad ( 1.4 )$$

Herein, wᵢⱼ is a weight of a connection between a node j and a node i, and sᵢ is an input weighted sum of the node i.

3. Split learning: In split learning, the neural network is divided into two parts. One part is deployed on a server, and the other part is deployed on a node. Starting from a node, the node performs joint learning with the server. In a forward process, the node performs calculation on an input based on the part of the neural network obtained through splitting, and transmits an output result, that is, a middle layer feature of the entire neural network, to the server. The server performs calculation on the middle layer feature based on the other part of the neural network obtained through splitting, to obtain a final output. In a backward process, the server calculates a gradient of the other part of the neural network based on a loss function, performs update, and sends a middle layer gradient to the node. The node calculates a gradient of the part of the neural network based on the middle layer gradient, and performs update. After a plurality of rounds of training, a first node transmits a model weight to a second node, and the second node starts from this to perform joint learning with the server.

4. Knowledge distillation: In knowledge distillation, model structures of the server and node may be inconsistent. For example, a model of the server is larger and includes more parameters. Model structures of nodes may also be inconsistent. The server obtains model parameters corresponding to node structures through distillation learning, and sends the model parameters to the nodes. Each node updates a local model parameter.

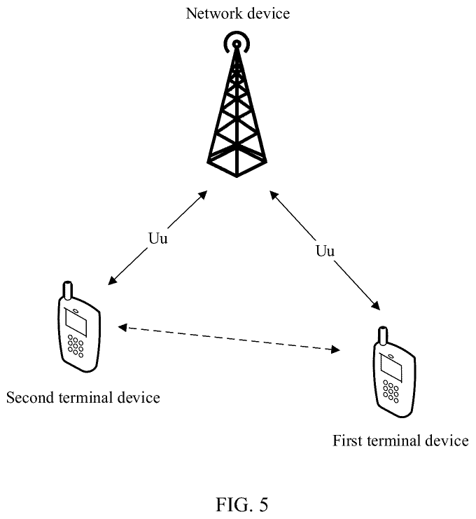

FIG. 5 is a schematic diagram of an architecture of a communication system to which this application is applicable. As shown in FIG. 5, the wireless communication system includes cells. Each cell includes one network device. The network device provides a communication service for a plurality of terminal devices. The terminal device has mobility, and may be handed over between cells. Alternatively, the network device moves, so that the terminal device is handed over between cells. The network device and the terminal device are connected through a Uu interface. The network devices are connected through an X2 interface. Point-to-point communication may also be implemented in the wireless communication system. For example, a plurality of terminal devices communicate with each other.

FIG. 5 is merely an example for description, and does not specifically limit a quantity, a type, a connection manner, and the like of network devices and terminal devices in this application.

The technical solutions of this application may be applied to a cellular system related to the 3rd generation partnership project (3GPP), for example, a 4th generation (4G) communication system such as a long term evolution (LTE) system, or a 5th generation (5G) communication system such as a new radio (NR) system: or may be applied to a wireless fidelity (Wi-Fi) system, or a communication system that supports convergence of a plurality of wireless technologies, or an evolved communication system after 5G such as a 6th generation (6G) communication system.

The terminal device mentioned in embodiments of this application may be a device having wireless sending and receiving functions, and may be a user equipment (UE), an access terminal, a subscriber unit, a subscriber station, a mobile station, a remote station, a remote terminal, a mobile device, a user terminal, a wireless communication device, a user agent, or a user apparatus. Alternatively, the terminal device may be a satellite phone, a cellular phone, a smartphone, a wireless data card, a wireless modem, a machine-type communication device, a cordless phone, a session initiation protocol (SIP) phone, a wireless local loop (WLL) station, a personal digital assistant (PDA), a handheld device having a wireless communication function, a computing device, another processing device connected to a wireless modem, a vehicle-mounted device, a communication device mounted on a high-altitude aircraft, a wearable device, an unmanned aerial vehicle, a robot, a terminal in device-to-device (D2D) communication, a terminal in vehicle to everything (V2X), a virtual reality (VR) terminal device, an augmented reality (AR) terminal device, a wireless terminal in industrial control, a wireless terminal in self-driving, a fireless terminal in remote medical, a wireless terminal in a smart grid, a wireless terminal in transportation safety, a wireless terminal in a smart city, a wireless terminal in a smart home, a terminal device in a future communication network, or the like. This is not limited in this application.

The network device mentioned in embodiments of this application may be a device having wireless sending and receiving functions and is configured to communicate with the terminal device, or may be a device that connects the terminal device to a wireless network. The network device may be a node in a radio access network, and may also be referred to as a base station or may be referred to as a radio access network (RAN) node (or device). The network device may be an evolved nodeB (evolved NodeB, eNB, or eNodeB) in LTE, a next generation nodeB (gNB) in a 5G network, a base station in a future evolved public land mobile network (PLMN), a broadband network gateway (BNG), an aggregation switch, a non-3GPP access device, or the like. Optionally, the network device in embodiments of this application may include various forms of base stations, for example, a macro base station, a micro base station (also referred to as a small cell), a relay station, an access point, a device implementing functions of a base station in an evolved communication system after 5G, an access point (AP) in a Wi-Fi system, a transmission and reception point (TRP), a transmission point (TP), a mobile switching center, or a device implementing functions of a base station in D2D, V2X, and machine-to-machine (M2M) communication; and may further include a central unit (CU) and a distributed unit (DU) in a cloud radio access network (C-RAN) system, and a network device in a non-terrestrial communication network (NTN) communication system, that is, the network device may be deployed on a high-altitude platform or a satellite. This is not specifically limited in embodiments of this application.

The network device in embodiments of this application may further have a computing capability, and may be a network node having a computing capability. For example, the network device may be an AI node on a network side (an access network or a core network), a computing node, a RAN node having an AI capability, or a core network element having an AI capability.

In this application, “indicate” may include “directly indicate” and “indirectly indicate”. When a case in which a specific piece of indication information indicates A is described, the following cases may be included: The indication information directly indicates A or indirectly indicates A. However, this does not indicate that the indication information definitely carries A. In embodiments of this application, descriptions such as “when . . . ” and “if” all mean that the device performs corresponding processing in a specific objective case, and do not limit time and do not require the device to perform determining during implementation nor mean other limitation.

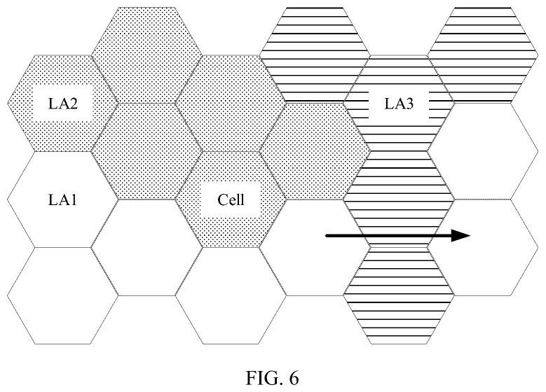

The following describes in detail the wireless communication method in embodiments of this application with reference to FIG. 6 to FIG. 14.

FIG. 6 is a schematic diagram of AI area configuration according to some embodiments of this application.

This embodiment of this application provides an AI area. The AI area may also be referred to as a learning area (LA). The AI area includes one or more cells. The cell may be an area covered by a network device or a part of a network device. In the area, a terminal device may communicate with the network device through a radio channel.

In a possible implementation, the AI area is determined based on one or more pieces of the following information: an environment similarity, a data similarity, an AI task, or a model version. In other words, cells having a similar environment or data, or cells having a same model version or AI task may be configured as one AI area. For example, the environment similarity may be a similarity of building distribution in coverage of a network device, the data similarity may include a similarity of data used in tasks such as channel information compression and a multi-antenna codebook, the AI task may be AI-based data transmission, environment perception, and the like, and the model version may be neural network models having different model structures and parameters.

Devices belonging to a same AI area may perform training by using a same initial neural network model, or may perform model inference by using a same initial model, or may participate in joint training, thereby improving model accuracy. When the terminal device moves between cells in the same AI area, the terminal device may not notif≤ the network device of a location change of the terminal device. When the terminal device in an idle state is paged, paging is performed in each cell in the AI area in which the terminal device is located. Paging means that the network device establishes a connection to a terminal device by using a wireless communication method. When the terminal device moves in the same AI area, knowledge transfer between a plurality of cells can be implemented. In other words, model training is performed based on data of the plurality of cells. In addition, in the same AI area, the terminal device does not need to frequently download and update a trained model, to save a radio resource.

A larger AI area indicates a larger quantity of cells included in the AI area. The terminal does not need to download a new trained model in this area, thereby reducing model interaction overhead. However, because the same model is used in the same AI area, the model needs to adapt to scenarios of different cells, and performance of the model may deteriorate. Therefore, the performance of the model and model interaction overhead need to be both considered for a size of the AI area.

In some implementations of this application, the AI area is identified by using an AI area identifier. As shown in Table 1, the AI area identifier may be independently configured based on each AI task. In other words, each AI task corresponds to one AI area identifier. For example, the AI task is marked as AI ID-N, and the AI area identifier is marked as AI area code-N. Optionally, the AI area code-N may be a hexadecimal number.

TABLE 1

| AI task list | AI area identifier |
|---|---|
| AI ID-1 | AI area code-1 |
| AI ID-2 | AI area code-2 |
| . . . | . . . |
| AI ID-N | AI area code-N |

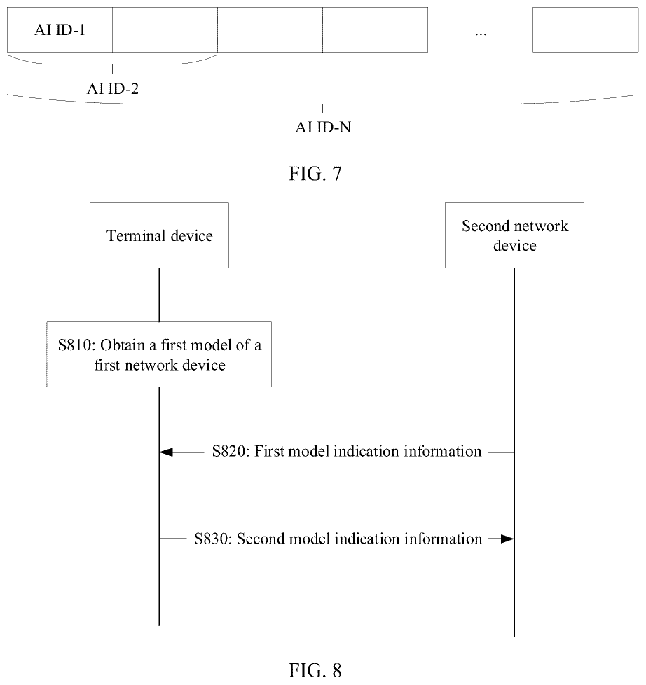

FIG. 7 is a schematic diagram of defining an AI area identifier based on an AI task according to some embodiments of this application. The AI area identifier may be configured in a nested manner based on an AI task. In other words, hierarchical AI area information is formed based on a plurality of AI tasks. As shown in FIG. 7, AI ID-1 is a first-level AI task, and AI ID-N is an N^{th}-level AI task. Coverage of the first-level AI task is the largest. In other words, a quantity of covered cells is the largest. Coverage of a final-level AI task is the smallest. Optionally, AI areas belonging to a same level may be same-level AI areas having a same identifier or partially the same identifier. For example, a unit represented by each grid in the figure may be 8 bits.

In some implementations of this application, the AI area identifier may be defined based on an environment similarity or a data similarity. AI areas having different environments or data usually use different models. There is a mapping relationship between a model and an environment or data. A used model is marked as model ID-1. A definition manner of the AI area identifier is shown in Table 2.

TABLE 2

| Model list | AI area identifier |
|---|---|
| Model ID-1 | AI area code-1 |
| Model ID-2 | AI area code-2 |
| . . . | . . . |
| Model ID-N | AI area code-N |

In another possible implementation, the AI area identifier may be defined based on a model version, as shown in Table 3.

TABLE 3

| Model list | AI area identifier |
|---|---|
| Model version-1 | AI area code-1 |
| Model version-2 | AI area code-2 |
| . . . | . . . |
| Model version-N | AI area code-N |

In a possible implementation, the AI area includes a core network device, for example, a session management function (SMF) network element, a user plane function (UPF) network element, or an access and mobility management function (AMF) network element. The core network device may identify the AI area by using the AI area identifier. The AI area identifier may be an AI area ID, an AI area code, an AI area address, or the like.

In a possible implementation, if a first network device and/or a second network device belong/belongs to a same AI area, a terminal device may perform model ensembling. The ensemble model is obtained by the terminal device by performing model ensembling on a first model and a second model when an AI area corresponding to the first network device is the same as an AI area corresponding to the second network device. The same AI area may indicate the same AI area identifier or partially the same AI area identifier. For example, the AI area identifier may be a state described by using 16 bits. If only first 12 bits of the 16 bits are used for an AI area identifier of LA1, AI area identifiers of cells in LA1 may be partially the same, that is, have the same first 12 bits. If the first network device and the second network device belong to different AI areas, as shown in FIG. 6, geographical locations of cells in a same AI area may be not adjacent. When the terminal device moves from LA1 to LA3 in an arrow direction, the terminal device does not perform model ensembling, but caches a model of a source network device. When the terminal device continues to move to LA1 in the arrow direction, the terminal device performs model ensembling.

In a possible implementation, the first network device sends a corresponding AI area identifier of the first network device to the terminal device, and/or the second network device sends a corresponding AI area identifier of the second network device to the terminal device. Correspondingly, the terminal device obtains the AI area identifier of the first network device and/or the AI area identifier of the second network device. Optionally, a third network device sends the corresponding AI area identifier of the first network device and/or the corresponding AI area identifier of the second network device to the first network device and/or the second network device. The third network device may be a core network device. Optionally, the network device may send the AI area identifier to the terminal device through broadcasting by using RRC signaling, MAC CE signaling, or the like.

In a possible implementation, the terminal device maintains configuration information of an AI area, and performs an AI area update when being handed over between cells. The network device stores model information of the terminal device based on the AI area, and pushes or responds to model update when handover between cells occurs.

An embodiment of this application provides a wireless communication method, to implement cross-cell knowledge transfer and improve performance of a neural network model. FIG. 8 is a schematic diagram of interaction in the method. FIG. 8 shows steps or operations in the method. However, these steps or operations are merely examples. In the technical solutions provided in this application, other operations or variations of the operations in FIG. 8 may be further performed. The method may be applied to the foregoing AI area scenario, and is also applicable to another communication scenario. This is not limited in this application.

S810: A terminal device obtains a first model of a first network device.

That the terminal device obtains the first model of the first network device may be as follows: When the terminal device has not completed handover from the first network device to a second network device, the terminal device receives the first model sent by the first network device; or when the terminal device has completed handover from the first network device to a second network device, the terminal device reads the first model from a memory of the terminal device. The first model includes a model parameter such as a weight or a gradient.

The first model is obtained by the first network device by performing model ensembling on a local model sent by the terminal device in coverage of the first network device. The terminal device in the coverage of the first network device may be a terminal device connected to the first network device. The local model may be obtained by the terminal device by performing model training based on local data that includes a model parameter such as a weight and a gradient. Training of the local model may be a process of continuous iteration and update. Therefore, the local model may change continuously. The local model in embodiments of this application may be a model obtained through a newest round of training of the local model when the terminal device exchanges information. Similarly, a process in which the first network device performs model ensembling on a received local model may be a process of continuous iteration and update. The first model may change continuously. The first model in embodiments of this application may be a model obtained by the first network device through a newest round of model ensembling when information exchange occurs.

A manner in which the first network device performs model ensembling on the local model may be a model ensembling manner used in any one of conventional federated learning, split learning, and knowledge distillation.

S820: The second network device sends first model indication information to the terminal device, and correspondingly, the terminal device receives the first model indication information from the second network device.

When the terminal device has not completed handover from the first network device to the second network device, the second network device sends the first model indication information to the first network device, and the first network device forwards the first model indication information to the terminal device: or when the terminal device has completed handover from the first network device to the second network device, the second network device directly sends the first model indication information to the terminal device.

The first model indication information indicates a second model of the second network device. Each terminal device in coverage of the second network device sends a local model to the second network device. The second network device performs model ensembling on the received local model to obtain the second model. Similarly, a process in which the second network device performs model ensembling on the received local model may be a process of continuous iteration and update. Therefore, the second model may change continuously. The second model in some embodiments of this application is a model obtained by the second network device through a newest round of model ensembling when information exchange occurs. The second model may include a model parameter such as a weight or a gradient.

A manner in which the second network device performs model ensembling on the received local model may be a model ensembling manner used in any one of conventional federated learning, split learning, and knowledge distillation.

The first model indication information may further include a model ensembling parameter of the second network device. The model ensembling parameter of the second network device is a parameter used when the second network device performs model ensembling on the local model received by the second network device, that is, ensembling configuration information. The model ensembling parameter includes one or more of: a quantity of model ensembling rounds, a data volume, a learning rate, or an optimizer. The data volume affects accuracy of the model. The learning rate is used for controlling a gradient descent step. The optimizer is an algorithm for updating a model parameter based on a loss function by using the gradient descent method or a variation method of the gradient descent method to reduce a value of the loss function. The gradient descent method includes a standard gradient descent method, a stochastic gradient descent method, a batch gradient descent method, and the like. The variation method includes a momentum optimization method, and the like. The terminal device adjusts, based on the received model ensembling parameter of the second network device, a parameter used for performing model ensembling on the first model and the second model by the terminal device. This helps the terminal device determine an appropriate model ensembling parameter, thereby improving accuracy of a neural network model.

S830: The terminal device sends second model indication information to the second network device, and correspondingly, the second network device receives the second model indication information from the terminal device.

When the terminal device has not completed handover from the first network device to the second network device, the terminal device sends the second model indication information to the first network device, and the first network device forwards the second model indication information to the second network device; or when the terminal device has completed handover from the first network device to the second network device, the terminal device directly sends the second model indication information to the second network device.

The second model indication information indicates an ensemble model of the first model and the second model. The terminal device performs model ensembling on the received first model and second model to obtain the ensemble model. A manner in which the terminal device performs model ensembling may be a model ensembling manner used in any one of conventional federated learning, split learning, or knowledge distillation.

In some implementations of this application, the second model indication information includes a model parameter of the ensemble model, for example, a weight and a gradient. The second network device may perform a new round of model ensembling based on the model parameter of the ensemble model. Optionally, after receiving the ensemble model, the second network device sends the ensemble model to the terminal device in the coverage of the second network device. The terminal device updates the local model based on the ensemble model, performs a new round of training of the local model, and sends a result of the new round of training of the local model to the second network device. In this way, the second network device performs a new round of model ensembling. Alternatively, after the second network device receives the ensemble model, the second network device directly performs model ensembling on the ensemble model and the second model.

In some implementations of this application, the terminal device sends third model indication information to the first network device. The third model indication information indicates the ensemble model. After receiving the ensemble model, the first network device sends the ensemble model to the terminal device in the coverage of the first network device. The terminal device updates the local model based on the ensemble model, performs a new round of training of the local model, and sends a result of the new round of training of the local model to the first network device. In this way, the first network device performs a new round of model ensembling. Alternatively, after the first network device receives the ensemble model, the first network device directly performs model ensembling on the ensemble model and the first model.

In some implementations of this application, before the terminal device receives the first model indication information from the second network device, the terminal device sends capability information to the first network device, and the first network device sends handover request information to the second network device, where the handover request information includes the capability information; or the terminal device sends capability information to the second network device, where the capability information includes computility and/or storage space of the terminal device. Correspondingly, the second network device receives the handover request information from the first network device. The handover request information includes the capability information. Alternatively, the second network device receives the capability information of the terminal device.

The second network device determines, based on the capability information, that the terminal device has a model ensembling capability. The second network device sends the handover request acknowledgment information to the first network device. The handover request acknowledgment information includes ensembling indication information. The ensembling indication information indicates to the terminal device to perform model ensembling. The first network device sends the ensembling indication information to the terminal device. Alternatively, the second network device sends the ensembling indication information to the terminal device. Correspondingly, the terminal device receives the ensembling indication information from the first network device or the second network device. The ensemble model is obtained by the terminal device by performing model ensembling on the first model and the second model based on the ensembling indication information.

In some implementations of this application, the terminal device receives AI configuration information from the third network device. The AI configuration information includes AI operation indication information and one or more of the following: a model parameter, a data type, or a data processing type. The AI operation indication information includes an AI area identifier. The AI operation indication information indicates an AI operation corresponding to the terminal device. The AI operation includes one or more of: model inference, model evaluation, model training, or data processing. The third network device may be a core network.

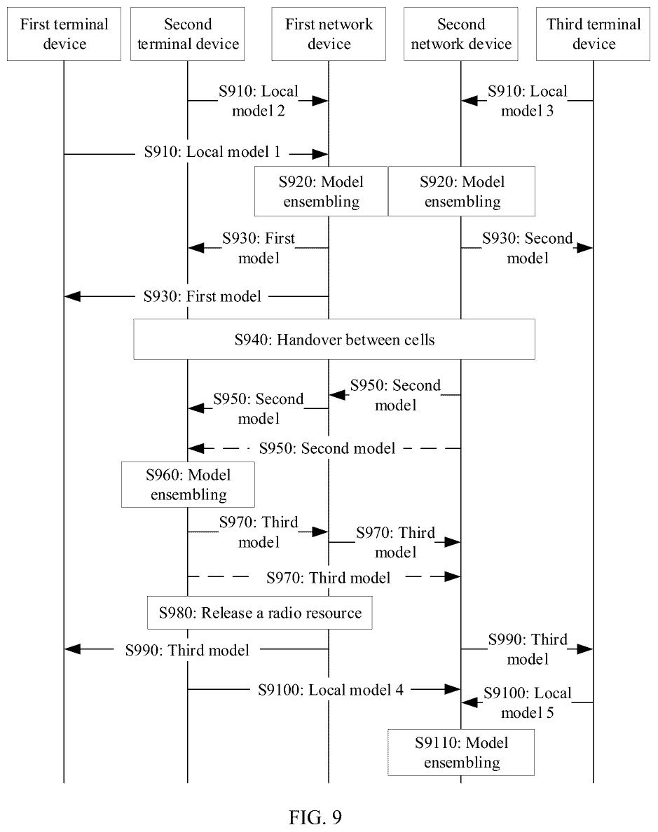

FIG. 9 is a schematic diagram of interaction in another wireless communication method according to some embodiments of this application. A model ensembling process on a terminal device side is combined in a handover procedure.

S910: A terminal device sends a local model to a network device, and correspondingly, the network device receives the local model sent by the terminal device.

For example, a first terminal device and a second terminal device are located in coverage of a first network device. A third terminal device is located in coverage of the second network device. Each terminal device separately trains a model locally, and reports a trained local model to a corresponding network device. In other words, the first terminal device and the second terminal device respectively report a local model 1 and a local model 2 to the first network device, and the third terminal device reports a local model 3 to the second network device.

The figure shows merely examples of the first terminal device, the second terminal device, and the third terminal device, but does not indicate that there are only the first terminal device and the second terminal device in the coverage of the first network device, there is only the third terminal device in the coverage of the second network device, and an object in each round of model ensembling of each network device is a trained local model reported by a terminal device in coverage of the network device.

S920: The network device performs model ensembling on the received local model.

For example, the first network device performs model ensembling on a local model 1 and a local model 2, to obtain a first model. The first model may also be referred to as a global model 1. The second network device performs model ensembling on a local model 3, to obtain a second model. The second model may also be referred to as a global model 2. The local model is obtained by the terminal device by performing model training based on local data. The local model includes model parameters such as a weight and a gradient. The first model and the second model are models obtained by the network device by performing model ensembling, and include model parameters such as a weight and a gradient.

Optionally, a manner in which the network device performs model ensembling on the received local model may be a model ensembling manner used in any one of conventional federated learning, split learning, or knowledge distillation.

S930: The first network device sends the first model, and the second network device sends the second model; and correspondingly, the terminal device receives the corresponding first model or the corresponding second model.

The network device sends an ensemble model on a network device side to the terminal device in the coverage of the network device. The first network device sends the first model to the first terminal device and the second terminal device, and the second network device sends the second model to the third terminal device. The terminal device updates the local model after receiving the first model or the second model, and performs a new round of training of the local model based on an updated model. A manner in which the network device sends the first model or the second model to the terminal device may be a broadcast manner.

S940: The terminal device is handed over between cells.

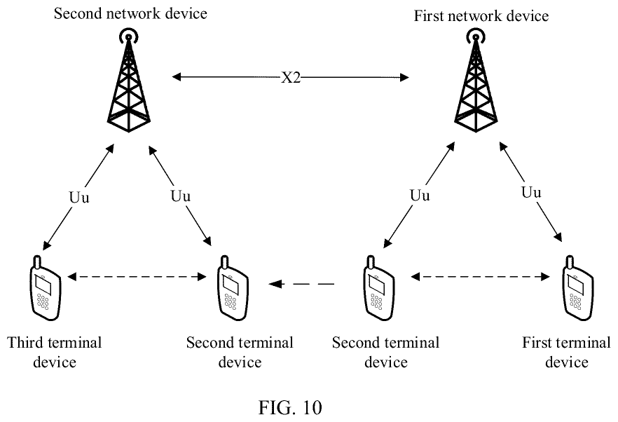

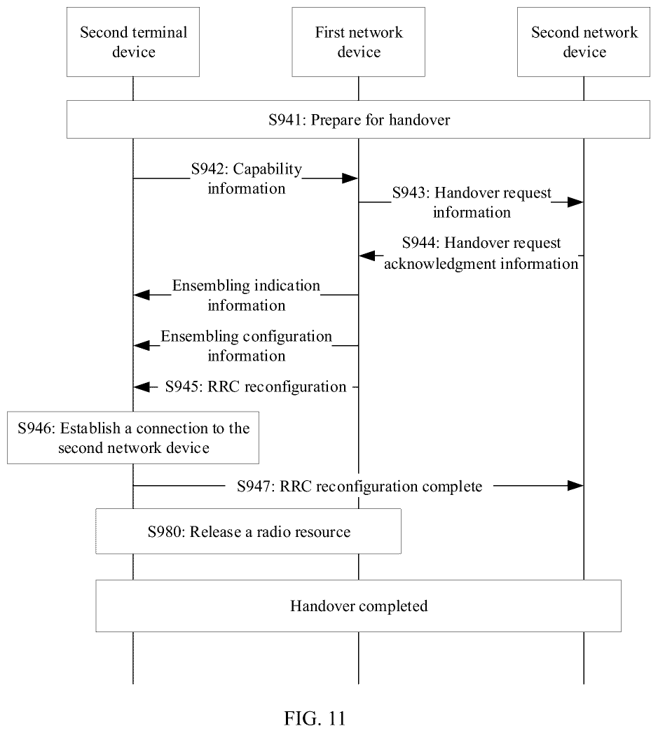

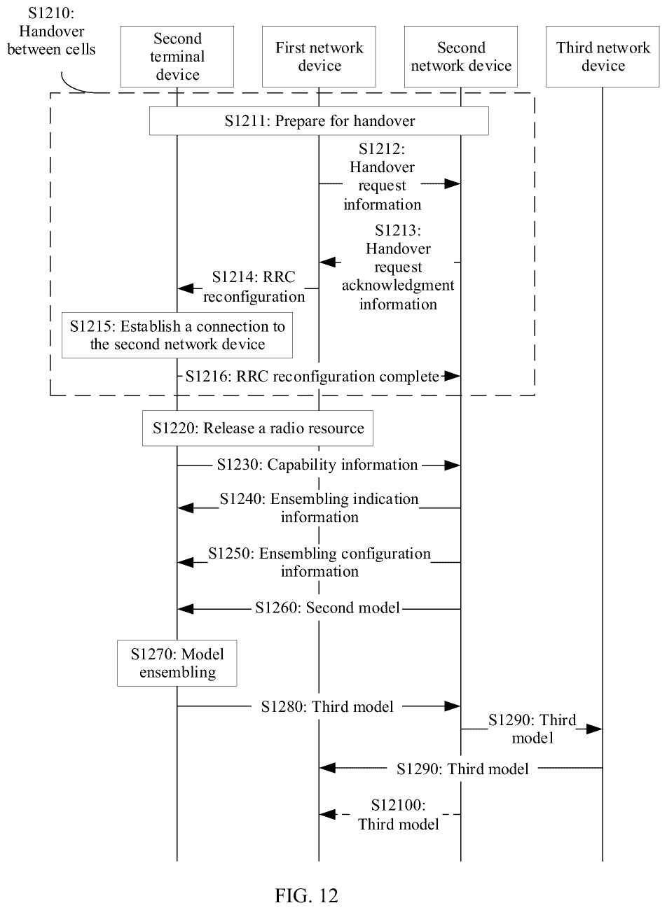

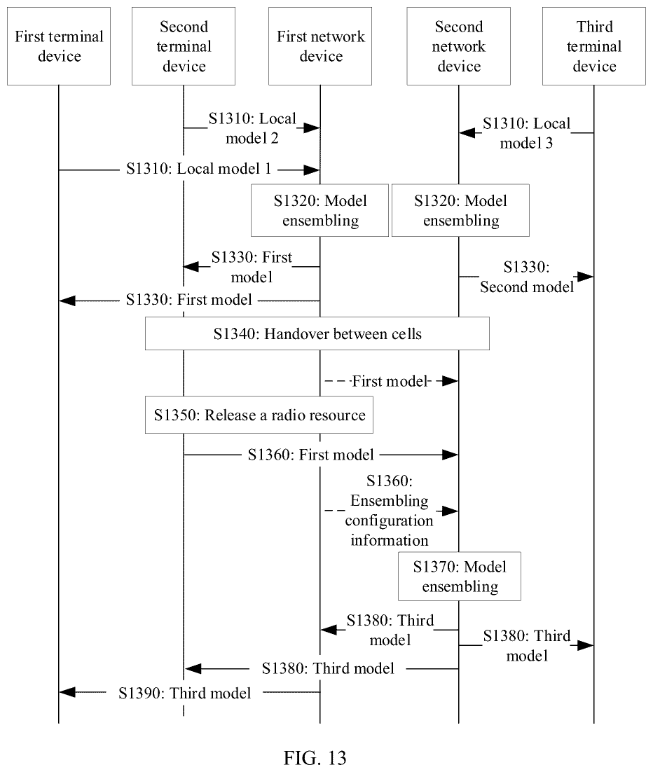

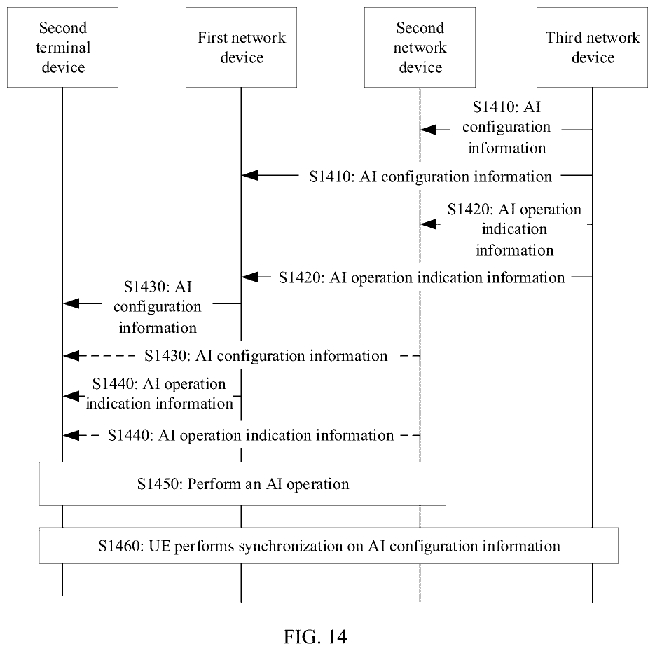

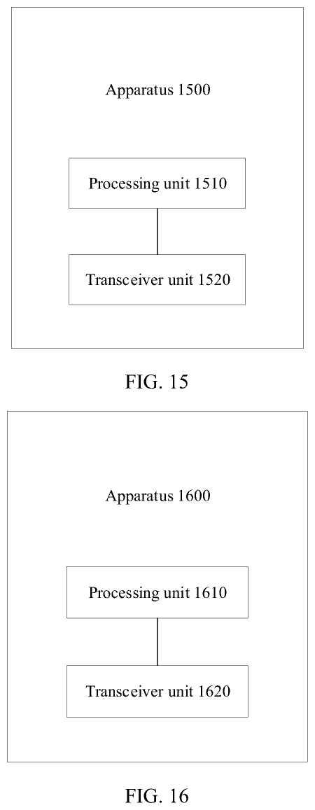

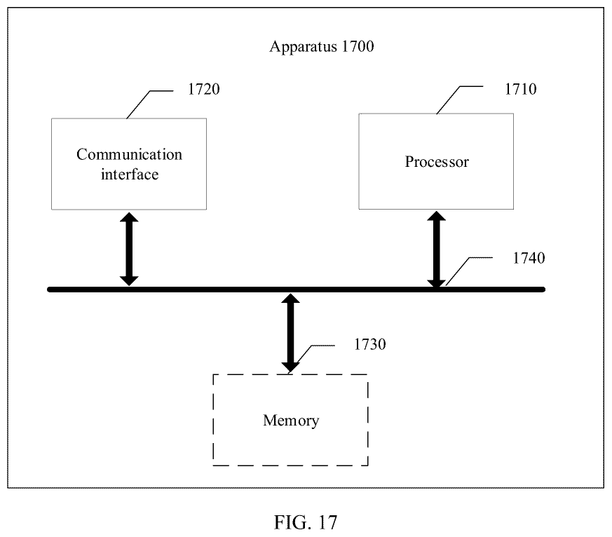

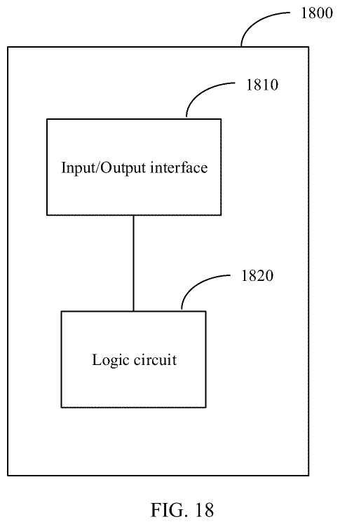

For example, the second terminal device is handed over between cells. A schematic diagram of the scenario is shown in FIG. 10. The second terminal device moves from the coverage of the first network device to the coverage of the second network device. The second terminal device is triggered to be handed over from the first network device to the second network device. FIG. 10 is merely a schematic diagram of an example of a scenario in which the terminal device moves. It is also possible that the network device moves. This is not limited in this application.

The cell handover procedure, that is, step S940, includes steps S941 to S947 shown in FIG. 11. After step S946, the second terminal device establishes a connection to the second network device. In other words, the second terminal device may directly communicate with the second network device.

S950: The second network device sends the second model to the second terminal device, and correspondingly, the second terminal device receives the second model.

The second network device sends the second model to the second terminal device. The second model may also be sent by using first model indication information. The first model indication information indicates the second model. The second model is used by the second terminal device to perform model ensembling on a terminal device side, to implement mixed use of terminal device data between cells. In other words, model training is performed based on data of a plurality of cells, to implement inter-cell knowledge transfer.

In a possible implementation, when the second terminal device has not established a connection to the second network device, the second network device first sends the second model to the first network device, and the first network device forwards the second model to the second terminal device. In other words, step S950 may be performed before step S946.

In another possible implementation, the second terminal device establishes a connection to the second network device, and the second network device may directly send the second model to the second terminal device. In other words, step S950 may be performed after step S946.

Optionally, the second model may further include a model ensembling parameter of the second network device, that is, ensembling configuration information. The model ensembling parameter includes one or more of: an initial parameter, a learning rate, a quantity of model ensembling rounds, a data volume, or an optimizer. The second terminal device adjusts, based on the ensembling configuration information, a parameter used when model ensembling is performed on the first model and the second model, thereby improving accuracy of the model.

S960: The second terminal device performs model ensembling.

The second terminal device performs model ensembling on the received first model and second model to obtain an ensemble model, that is, a third model. The third model may also be referred to as a global model 3. The terminal device performs model ensembling on the first model and the second model, to implement mixed use of terminal device data between cells. In other words, model training is performed based on data of a plurality of cells, to implement inter-cell knowledge transfer.

In a possible implementation, the second terminal device may perform, based on local data, retraining on the first model and the second model through knowledge distillation, to obtain an ensemble model.

For example, as shown in Formula (1.5), neural network weight parameters w₁ and w₂ are respectively weight parameter values obtained after the first network device and the second network device perform a plurality of rounds of model ensembling and update, that is, a plurality of cycles of steps S910 to S930. A process in which the second terminal device combines w₁ and w₂ is to obtain new w_{1,2}, to minimize a loss function of user data of the first network device and the second network device. The process may be obtained by using an optimization process of Formula (1.5):

$${min}_{{w}_{1 , 2}} {E}_{x ∼ {D}_{1}} [ L ( y , \hat{y} ; {w}_{1 , 2} ) + η \cdot {D}_{K L} ( σ ( f ( x ) ; {w}_{1} ) , σ ( f ( x ) ; {w}_{2} ) ) ] \qquad ( 1.5 )$$

The optimized parameter w_{1,2} may be initialized to w₂, D₁ is a local dataset of the terminal device, y is an output value of the ensemble model of the terminal device, ŷ is a real output value corresponding to an input value x of the ensemble model, L(y, ŷ; w_{1,2}) is a loss function when a weight is w_{1,2}, σ(f(x); wᵢ) is an output of a neural network when a weight is wᵢ, DKL (,) represents a prediction distance between a neural network of the first network device and a neural network of the second network device, η is used to balance a difference between a neural network loss and the two neural networks, E is an average function. Update is performed by using a gradient descent method or the like, to obtain a weight obtained after ensembling.

Optimization of this formula is to use a neural network weight of the second network device as an initial value, and focus on transferring a model of the first network device to the second network device. This formula is merely used as an example, and cannot be used as a limitation on the model ensembling method in embodiments of this application. For example, for model ensembling on the second terminal device side, a weight of the first network device may be used as an initial value, and a focus is to transfer a model of the second network device to the first network device.

In another possible implementation, the terminal device performs model ensembling in a split learning manner. The neural network model is divided into two parts that are respectively deployed on the terminal device and the network device. The first network device separately performs model training on a terminal device in the coverage of the first network device, and obtains the first model after a plurality of rounds of training. Correspondingly, the second network device separately performs model training on a terminal device in the coverage of the second network device, and obtains the second model after a plurality of rounds of training. For example, the second terminal device is handed over from the first network device to the second network device, the second terminal device performs model training on the second model of the second network device based on the first model to obtain the third model, and the terminal device or the second network device sends the third model to the first network device.

S970: The second terminal device sends the third model to the second network device, and correspondingly, the second network device obtains the third model.

In a possible implementation, the second terminal device has not established a connection to the second network device. In other words, step S970 is performed between steps S944 and S946. The second terminal device sends the third model to the first network device, and the first network device forwards the third model to the second network device. The third model may be sent by using third model indication information. The third model indication information indicates the third model.

In a possible implementation, the second terminal device has established a connection to the second network device. In other words, step S970 is performed after step S946. The second terminal device directly sends the third model to the second network device.

S980: The second terminal device and the first network device release a radio resource.

In some implementations of this application, after model ensembling on a terminal device side is completed and the ensemble model is sent to each network device by using model indication information, the second terminal device and the first network device release a radio resource. The radio resource includes a time-frequency resource, broadcast signal configuration, a frame structure, information data, and the like that are required for communication between the second terminal device and the first network. The second terminal device is disconnected from the first network device. The second terminal device completes a handover procedure.

S990: The first network device sends the third model to the first terminal device, and the second network device sends the third model to the third terminal device, and correspondingly, the terminal devices receive the third model.

After receiving the third model, that is, the ensemble model on the terminal device side, each terminal device updates a local model based on the ensemble model, and performs a new round of training of the local model, to implement mixed use of data between cells and implement knowledge transfer.

S9100: The second terminal device and the third terminal device report the local models to the second network device, and correspondingly, the second network device receives the local models corresponding to the terminal devices.

The second network device side is used as an example. The terminal device and the network device perform a new round of model training or model ensembling based on the ensemble model. After the second terminal device completes handover between cells, both the second terminal device and the third terminal device are located in the coverage of the second network device. The second terminal device and the third terminal device respectively update the local models based on the ensemble model, perform a new round of model training, respectively obtain a local model 4 and a local model 5, and respectively send the local model 4 and the local model 5 to the second network device, so that the network device performs a new round of model ensembling.

Similarly, a terminal device on the first network device side also performs update and training of the local model based on the ensemble model, and the first network device performs new model ensembling.

S9110: The second network device performs model ensembling.

The second network device performs model ensembling on the received local model 4 and local model 5.

Model training and ensembling are a continuous update and iteration process until model convergence. Each round of new model training is performed based on a parameter obtained after a previous round of model ensembling, and each round of model ensembling is performed based on an updated model training parameter. In some embodiments of this application, only a model training process and a model ensembling process before and after handover of the terminal device are shown. However, it does not indicate that the model training and ensembling processes in a system are performed only in this round.

FIG. 11 is a schematic diagram of a handover procedure according to some embodiments of this application. A model ensembling process on a terminal device side may be combined in the handover procedure. For example, a second terminal device is handed over from a first network device to a second network device.

S941: The second terminal device, the first network device, and the second network device prepare for handover.

Handover preparation may include that the first network device configures a channel measurement report of the second terminal device, the second terminal device measures and reports channel quality, and the like.

S942: The second terminal device sends capability information to the first network device, and correspondingly, the first network device receives the capability information.

In some implementations of this application, the second terminal device has not established a connection to the second network device, and the second terminal device sends capability information to the first network device. The capability information includes computility and/or storage space of the second terminal device. The capability information may indicate whether the second terminal device has a model ensembling capability. The computility is computing ability of the second terminal device, and may be floating-point operations per second (FLOPS) of the second terminal device.

In some implementations of this application, the second terminal device determines whether the first network device and the second network device belong to a same AI area. If the first network device and the second network device belong to the same AI area, the second terminal device sends the capability information to the first network device.

In a possible implementation, the terminal device obtains an AI area identifier of the first network device and an AI area identifier of the second network device, and determines, based on the AI area identifier of the first network device and the AI area identifier of the second network device, whether the first network device and the second network device belong to the same AI area.

That the terminal device obtains the AI area identifier of the first network device may be as follows: Before the terminal device is handed over between cells, the first network device sends the corresponding AI area identifier of the first network device to the terminal device, and the terminal device stores the AI area identifier of the first network device.

That the terminal device obtains the AI area identifier of the second network device may be as follows: The second network device sends the corresponding AI area identifier of the second network device to the first network device, and the first network device sends the corresponding AI area identifier of the second network device to the terminal device.

S943: The first network device sends handover request information to the second network device, and correspondingly, the second network device receives the handover request information.

In some implementations of this application, the first network device sends the handover request information to the second network device. The handover request information includes the capability information. The handover request information is used to request the second network device to establish a connection to the second terminal device. The capability information is used by the second network device to determine whether the second terminal device has the model ensembling capability.

S944: The second network device sends handover request acknowledgment information to the first network device, and correspondingly, the first network device receives the handover request acknowledgment information.

In some implementations of this application, if the second network device determines, based on the capability information, that the second terminal device has the model ensembling capability, and the second network device may establish a connection to the second terminal device, the second network device sends the handover request acknowledgment information to the first network device. The handover request acknowledgment information includes ensembling indication information. The ensembling indication information indicates to the second terminal device to perform model ensembling. The first network device sends the ensembling indication information to the second terminal device. Optionally, a manner of sending the ensembling indication information may be transparent transmission. After receiving the ensembling indication information, the second terminal device may perform model ensembling on a first model and a second model based on the ensembling indication information to obtain an ensemble model. In other words, the ensemble model is obtained by the second terminal device by performing model ensembling on the first model and the second model based on the ensembling indication information. For an example ensembling process, refer to step 960. Details are not described herein again.

In some implementations of this application, the handover request acknowledgment information may further include ensembling configuration information, that is, a model parameter used when the second network device performs model ensembling. The model parameter includes one or more of: an initial parameter, a learning rate, a quantity of model ensembling rounds, a data volume, or an optimizer. The first network device sends the ensembling configuration information to the second terminal device. A manner of sending the ensembling configuration information may be transparent transmission. The second terminal device may adjust, based on the ensembling configuration information, a parameter used when model ensembling is performed on the first model and the second model, thereby improving accuracy of the model.

In some implementations of this application, the handover request acknowledgment information may further include the AI area identifier of the second network device, and the first network device sends the AI area identifier of the second network device to the second terminal device. The second terminal matches the AI area identifier with the AI area identifier of the first network device, and determines whether the first network device and the second network device belong to the same AI area.

S945: The first network device sends RRC reconfiguration information to the second terminal device, and correspondingly, the second terminal device receives the RRC reconfiguration information.

The first network device sends the RRC reconfiguration information to the second terminal device. The RRC reconfiguration information includes radio resource configuration information. In other words, the first network device sends the radio resource configuration information of the second network device to the second terminal device, so that the second terminal device accesses the connection to the second network device on a radio resource.

S946: The second terminal device establishes the connection to the second network device.

After the connection is established, the second terminal device may communicate with the second network device.

S947: The second terminal device sends RRC reconfiguration complete information to the second network device, and correspondingly, the second network device receives the RRC reconfiguration complete information.

FIG. 12 is a schematic diagram of interaction in another wireless communication method according to some embodiments of this application. A model ensembling process on a terminal device side is performed after handover between cells is completed. An ensemble model may be forwarded by a third network device to a first network device, to save an air interface resource.

S1210: A second terminal device is handed over between cells.

For example, the second terminal device is handed over from the first network device to a second network device.

The cell handover procedure, that is, step S1210, includes steps S1211 to S1216.

S1211: The second terminal device, the first network device, and the second network device prepare for handover.

Handover preparation may include that the first network device configures a channel measurement report of the second terminal device, the second terminal device measures and reports channel quality, and the like.

S1212: The first network device sends handover request information to the second network device, and correspondingly, the second network device receives the handover request information.

The handover request information is used to request the second network device to establish a connection to the second terminal device.

S1213: The second network device sends handover request acknowledgment information to the first network device, and correspondingly, the first network device receives the handover request acknowledgment information.

The second network device sends the handover request acknowledgment information to the first network device. The handover request acknowledgment information is used to acknowledge that the second network device can establish a connection to the second terminal device.

S1214: The first network device sends RRC reconfiguration information to the second terminal device, and correspondingly, the second terminal device receives the RRC reconfiguration information.

The first network device sends the RRC reconfiguration information to the second terminal device. In other words, the first network device sends the radio resource configuration information of the second network device to the second terminal device, so that the second terminal device accesses the connection to the second network device on a radio resource.

S1215: The second terminal device establishes the connection to the second network device.

After the connection is established, the second terminal device may communicate with the second network device.

S1216: The second terminal device sends RRC reconfiguration complete information to the second network device, and correspondingly, the second network device receives the RRC reconfiguration complete information.

S1220: The second terminal device and the first network device release a radio resource.

After the second terminal device establishes the connection to the second network device, the second terminal device and the first network device may release the radio resource. In other words, the first network device releases the connection to the second terminal device. In this way, handover is completed.

S1230: The second terminal device sends capability information to the second network device, and correspondingly, the second network device receives the capability information.

In some implementations of this application, the second terminal device has completed handover between cells. The second terminal device establishes the connection to the second network device. The second terminal device directly sends the capability information to the second network device. The capability information includes computility and/or storage space of the second terminal device. The second network device determines, based on the capability information, whether the second terminal device has a model ensembling capability.

In some implementations of this application, the second terminal device determines whether the first network device and the second network device belong to a same AI area. If the first network device and the second network device belong to the same AI area, the second terminal device sends the capability information to the second network device.

In a possible implementation, the second terminal device further obtains an AI area identifier of the first network device and an AI area identifier of the second network device, and determines, based on the AI area identifier of the first network device and the AI area identifier of the second network device, whether the first network device and the second network device belong to the same AI area.

That the second terminal device obtains the AI area identifier of the first network device may be as follows: Before the terminal device is handed over between cells, the first network device sends the corresponding AI area identifier of the first network device to the terminal device, and the terminal device stores the AI area identifier of the first network device.

That the second terminal device obtains the AI area identifier of the second network device may be as follows: In a possible implementation, when the terminal device completes handover between cells, the second network device sends the corresponding AI area identifier of the second network device to the first network device, and the first network device sends the corresponding AI area identifier of the second network device to the terminal device. In another possible implementation, when the terminal device has completed handover from the first network device to the second network device, the second network device directly sends the corresponding AI area identifier of the second network device to the terminal device.

S1240: The second network device sends ensembling indication information to the second terminal device, and correspondingly, the second terminal device receives the ensembling indication information.

In some implementations of this application, the second terminal device has completed handover between cells, and the second terminal device establishes a connection to the second network device. After determining, based on the capability information, that the second terminal device has the model ensembling capability, the second network device directly sends the ensembling indication information to the second terminal device. The ensembling indication information indicates to the second terminal device to perform model ensembling. If the second network device determines that the second terminal device does not have the model ensembling capability, the second network device does not send the ensembling indication information. The ensemble model is obtained by the second terminal device by performing model ensembling on a first model and a second model based on the ensembling indication information.

In some implementations of this application, the second network device receives the AI area identifier of the first network device, or the capability information includes the AI area identifier of the first network device. The second network device determines, based on the AI area identifier, that the first network device and the second network device belong to a same AI area. If the first network device and the second network device belong to the same AI area and the second terminal device has the model ensembling capability, the second network device sends the ensembling indication information to the second terminal device.

S1250: The second network device sends the ensembling configuration information to the second terminal device, and correspondingly, the second terminal device receives the ensembling configuration information.

In some implementations of this application, the second network device sends the ensembling configuration information to the second terminal device, that is, a model ensembling parameter of the second network device. The model ensembling parameter includes one or more of: an initial parameter, a learning rate, a quantity of model ensembling rounds, a data volume, or an optimizer. The ensembling configuration information is used by the second terminal device to adjust, based on the ensembling configuration information, a parameter used when model ensembling is performed on the first model and the second model, to determine an appropriate model ensembling parameter, thereby improving accuracy of the model.

Optionally, the ensembling configuration information may also be sent after the second network device receives the capability information and before the second network device sends the ensembling indication information.

Optionally, the ensembling configuration information may also be sent together with the ensembling indication information. In other words, the second network device sends the ensembling indication information to the second terminal device. The ensembling indication information includes the ensembling configuration information.

S1260: The second network device sends the second model to the second terminal device, and correspondingly, the second terminal device receives the second model.

In some implementations of this application, after the second terminal device completes handover between cells, the second network device directly sends the second model to the second terminal device. The second model may be sent by using first model indication information. The first model indication information indicates the second model. The second model is used by the second terminal device to perform model ensembling on a terminal device side.

Optionally, the ensembling configuration information may also be sent together with the second model. In other words, the second network device sends the first model indication information to the second terminal device. The first model indication information indicates the second model and the ensembling configuration information. The ensembling configuration information is used by the second terminal device to adjust, based on the ensembling configuration information, the parameter used when model ensembling is performed on the first model and the second model, to determine an appropriate model ensembling parameter, thereby improving accuracy of the model.

S1270: The second terminal device performs model ensembling.

The second terminal device performs model ensembling on the received first model and second model to obtain an ensemble model, that is, a third model. The third model may also be referred to as a global model 3. When the terminal device is handed over between cells, mixed use of terminal device data between cells may be implemented. In other words, model training is performed based on data of a plurality of cells, to implement inter-cell knowledge transfer.

In some implementations of this application, the second terminal device may perform model ensembling on the model of the first network device and/or the model of the second network device in a used model ensembling manner of knowledge distillation or split learning in step S960. Details are not described herein again.

S1280: The second terminal device sends the third model to the second network device, and correspondingly, the second network device receives the third model.

In some implementations of this application, the second terminal device has completed the cell handover procedure, and the second terminal device directly sends the third model to the second network device. Alternatively, the third model may be sent by using second model indication information. The second model indication information indicates the third model, that is, the ensemble model of the first model and the second model. The second network device sends the third model to a terminal device in coverage of the second network device, so that the terminal device updates and trains a local model based on the third model, to implement inter-cell knowledge transfer.

S1290: The second network device sends the third model to the third network device, and the third network device forwards the third model to the first network device.

In some implementations of this application, the third network device may assist in sending the third model, and the third network device is a core network. This can prevent the second terminal device from maintaining dual connections to the first network device and the second network device, to save an air interface resource.

S12100: The second network device sends the third model to the first network device, and correspondingly, the first network device receives the third model.

In some implementations of this application, the second network device may further send the third model to the first network device. This prevents the second terminal device from maintaining the dual connections to the first network device and the second network device, to save an air interface resource.

FIG. 13 is a schematic diagram of interaction in another wireless communication method according to some embodiments of this application. After handover between cells is completed, a second network device performs model ensembling to implement knowledge transfer.

S1310: A terminal device reports a local model to a network device, and correspondingly, the network device receives the local model of the terminal device.

For example, a first terminal device and a second terminal device are located in coverage of a first network device. A third terminal device is located in coverage of the second network device. Each terminal device separately trains a model locally, and reports a local model to a corresponding network device. In other words, the first terminal device and the second terminal device respectively report a local model 1 and a local model 2 to the first network device, and the third terminal device reports a local model 3 to the second network device.

The figure shows merely examples of the first terminal device, the second terminal device, and the third terminal device: but does not indicate that there are only the first terminal device and the second terminal device in the coverage of the first network device, there is only the third terminal device in the coverage of the second network device, and an object in each round of model ensembling of each network device is a trained local model reported by a terminal device in coverage of the network device.

S1320: The network device performs model ensembling.

The network device separately performs ensembling on a local model reported by a terminal device in coverage of the network device. The first network device performs model ensembling on the local model 1 and the local model 2, to obtain a first model. The first model may also be referred to as a global model 1. The second network device performs model ensembling on the local model 3, to obtain a second model. The second model may also be referred to as a global model 2.

S1330: The first network device sends the first model, and the second network device sends the second model; and correspondingly, the terminal device receives the corresponding first model or the corresponding second model.

The first network device sends the first model to the first terminal device and the second terminal device. The second network device sends the second model to the third terminal device. The network device may broadcast the first model and the second model. After receiving the first model or the second model sent by the network device, the terminal device separately updates the local model, and performs a new round of training of the local model.

S1340: Handover is performed between cells.

For example, the second terminal device is handed over from the first network device to the second network device.

The network device performs the handover procedure in steps S1211 to S1216. Details are not described herein again.

S1350: The second terminal device and the first network device release a radio resource.

The first network device releases a connection to the second terminal device. The second terminal device completes a cell handover procedure.

S1360: The second terminal device or the first network device sends the first model to the second network device, and correspondingly, the first network device or the second network device receives the first model.

In some implementations of this application, when the second terminal device has not established a connection to the second network device, the first network device may send the first model to the second network device.

The first model may further include a model ensembling parameter of the first network device, that is, ensembling configuration information. The model ensembling parameter includes one or more of an initial parameter, a quantity of model ensembling rounds, a data volume, a learning rate, or an optimizer. The second network device may adjust, based on the received model ensembling parameter of the first network device, a parameter for performing model ensembling on the first model and the second model by the second network device, to determine an appropriate model ensembling parameter, thereby improving accuracy of a neural network model.

In some implementations of this application, when the second terminal device has established a connection to the second network device, the second terminal device may send the first model to the second network device. In addition, the first network device sends the ensembling configuration information to the second network device, that is, the model ensembling parameter of the first network device.

S1370: The second network device performs model ensembling.

The second network device performs model ensembling on the first model and the second model, to implement mixed use of data of a terminal device in the coverage of the first network device and data of a terminal device in the coverage of the second network device, thereby implementing inter-cell knowledge transfer.

S1380: The second network device sends a third model to the first network device, the second terminal device, and the third terminal device, and correspondingly, the first network device, the second terminal device, and the third terminal device receive the third model.

After a model ensembling process on the second network device side is completed, the second network device separately sends the obtained ensemble model to the second terminal device and the third terminal device; and the terminal device updates the local model based on the ensemble model, and performs a new round of training of the local model.

The second network device sends the third model to the first network device, and the first network device sends the third model to each terminal device in the coverage of the first network device. Each terminal device updates and trains a local model based on the ensemble model, to implement inter-cell knowledge transfer.

S1390: The first network device sends the third model to the first terminal device, and correspondingly, the first terminal device receives the third model.

The first network device sends the third model to a terminal device in the coverage of the first network device; and the terminal device updates a parameter of a local model based on the third model, and performs a new round of training of the local model.

FIG. 14 is a schematic diagram of an AI operation procedure based on an AI area according to some embodiments of this application. After an AI area is configured, a third network device sends configuration information of the AI area to each network device, and sends a related AI operation indication according to an actual requirement.

S1410: The third network device sends AI configuration information, and correspondingly, a first network device or a second network device receives the AI configuration information.

The third network device separately sends the AI configuration information to the first network device and the second network device. The AI configuration information includes one or more of: a model parameter, a data type, or a data processing type. The model parameter includes a weight of a neural network, and a parameter used for model training, such as a quantity of training rounds, a learning rate, and an optimizer. The data type may be one or more of: channel state information, location information, or image information of an environment. The data processing type may be data collection, evaluation, feedback, or the like. The first network device and the second network device send the AI configuration information to a terminal device in coverage of the first network device and the second network device. A manner of sending the AI configuration information may be transparent transmission.

In some implementations of this application, the AI configuration information includes AI operation indication information. The AI operation indication information includes an AI area identifier and AI operation content. If an AI area identifier of a network device matches the AI area identifier, the network device performs the AI operation content. If an AI area identifier of a network device does not match the AI area identifier, the network device does not perform the AI operation content. The AI operation includes one or more of: model inference, model evaluation, model training, or data processing. Model inference is to obtain an inference result through data processing by using a neural network model. Model evaluation is to evaluate performance of the used neural network model.

S1420: The third network device sends AI operation indication information, and correspondingly, the first network device or the second network device receives the AI operation indication information.

In some implementations of this application, the third network device separately sends the AI operation indication information to the first network device and the second network device. The AI operation indication information indicates the first network device, the second network device, and the terminal device in the coverage of the first network device and the second network device to perform the AI operation. The AI operation indication information carries the AI area identifier and the AI operation content. If an AI area identifier of a network device matches the AI area identifier, the network device performs the AI operation content. If an AI area identifier of a network device does not match the AI area identifier, the network device does not perform the AI operation content.

The first network device and the second network device send the AI operation indication information to the terminal device in the coverage of the first network device and the second network device. A manner of sending the AI operation indication information may be transparent transmission. The AI operation indication information may be transmitted through a PDCCH, and is scrambled by using an RNTI related to an AI task, to indicate an AI operation resource, for example, a time-frequency resource.

S1430: The first network device or the second network device sends the AI configuration information to the second terminal device, and correspondingly, the second terminal device receives the AI configuration information.

When the second terminal device has not completed handover from the first network device to the second network device, the second network device has not established a connection to the second terminal device. Therefore, the first network device sends the AI configuration information to the second terminal device.

When the second terminal device has completed handover from the first network device to the second network device, a connection between the second terminal device and the second network device has been established, and a connection between the second terminal device and the first network device has been broken. Therefore, the second network device sends the AI configuration information to the second terminal device.

In some implementations of this application, the AI configuration information includes the AI operation indication information. The AI operation indication information includes the AI area identifier and the AI operation content.

A manner in which the first network device or the second network device sends the AI configuration information to the second terminal device may be transparent transmission.

S1440: The first network device or the second network device sends the AI operation indication information to the second terminal device, and correspondingly, the second terminal device receives the AI operation indication information.

In some implementations of this application, when the second terminal device has not completed handover from the first network device to the second network device, the second network device has not established the connection to the second terminal device. Therefore, the first network device sends the AI operation indication information to the second terminal device.

When the second terminal device has completed handover from the first network device to the second network device, the connection between the second terminal device and the second network device has been established, and the connection between the second terminal device and the first network device has been broken. Therefore, the second network device sends the AI operation indication information to the second terminal device. The AI operation indication information indicates to the second terminal device to perform the AI operation.

The AI operation indication information carries the AI area identifier. If the AI area identifier matches an AI area identifier stored in the terminal device, the terminal device performs the AI operation content. If the AI area identifier does not match an AI area identifier stored in the terminal device, the terminal device does not perform the AI operation content.

S1450: The second terminal device, the first network device, and the second network device perform the AI operation.

The second terminal device, the first network device, and the second network device perform matching between AI area identifiers, and perform the AI operation.

Because the AI operation indication information received by the second terminal device, the first network device, and the second network device carries the AI area identifier, if the AI area identifier of the network device matches the AI area, the network device performs the AI operation. If the AI area identifier of the network device does not match the AI area identifier, the network device does not perform the AI operation.

Correspondingly, the second terminal device stores the AI area identifier, obtains the AI area identifier of the second network device when handover between cells occurs, and updates the AI area identifier. If the AI area identifier of the second terminal device matches the AI area identifier carried in the AI operation indication information, the second terminal device performs the AI operation. If the AI area identifier does not match the AI area identifier carried in the AI operation indication information, the second terminal device does not perform the AI operation.

S1460: The terminal device performs synchronization on the AI configuration information.

In some embodiments of this application, an AI operation can be triggered based on an AI area, to implement joint training of a plurality of cells in a same AI area.

FIG. 15 is a block diagram of a structure of a communication apparatus according to some embodiments of this application. The communication apparatus may be a terminal device, or may be a component (for example, a chip or a circuit) that can be used in a terminal device, or may be an apparatus that can be used with a terminal device. As shown in FIG. 15, the communication apparatus 1500 may include a processing unit 1510 and a transceiver unit 1520.

The processing unit 1510 is configured to obtain a first model of a first network device.

The transceiver unit 1520 is configured to receive, by the terminal device, first model indication information from a second network device. The first model indication information indicates a second model of the second network device.

The transceiver unit 1520 is further configured to send, by the terminal device, second model indication information to the second network device. The second model indication information indicates an ensemble model of the first model and the second model.

The transceiver unit 1520 is further configured to send, by the terminal device, third model indication information to the first network device. The third model indication information indicates the ensemble model.

The transceiver unit 1520 is further configured to send, by the terminal device, capability information to the first network device or the second network device.

The transceiver unit 1520 is further configured to receive, by the terminal device, ensembling indication information from the second network device. The ensembling indication information indicates to the terminal device to perform model ensembling.

The transceiver unit 1520 is further configured to receive, by the terminal device, AI configuration information from a third network device.

In a possible manner, the processing unit 1510 may be implemented by a processor, and the transceiver unit 1520 may be implemented by a transceiver. For examples of functions and beneficial effects of the processing unit 1510 and the transceiver unit 1520, refer to the methods shown in FIG. 8, FIG. 9, and FIG. 11 to FIG. 14. Details are not described herein again.

FIG. 16 is a block diagram of a structure of another communication apparatus according to some embodiments of this application. The communication apparatus may be a second network device, or may be a component (for example, a chip or a circuit) that can be used in the second network device. As shown in FIG. 16, the communication apparatus 1600 may include a transceiver unit 1620 and a processing unit 1610.

The transceiver unit 1620 is configured to send, by the second network device, first model indication information to a terminal device. The first model indication information indicates a second model of the second network device.

The transceiver unit 1620 is further configured to receive, by the second network device, second model indication information from the terminal device. The second model indication information indicates an ensemble model of a first model and the second model. The first model is a model that is of a first network device and that is obtained by the terminal device.

The transceiver unit 1620 is further configured to send, by the second network device, fourth model indication information to the first network device. The fourth model indication information indicates the ensemble model.

The transceiver unit 1620 is further configured to send, by the second network device, fifth model indication information to a third network device. The fifth model indication information indicating to the third network device to send the ensemble model to the first network device.

The transceiver unit 1620 is further configured to receive, by the second network device, handover request information from the first network device. The handover request information includes capability information. Alternatively, the transceiver unit 1620 is further configured to receive, by the second network device, the capability information from the terminal device.

The processing unit 1610 is configured to determine, by the second network device based on the capability information, that the terminal device has a model ensembling capability.

The transceiver unit 1620 is further configured to send, by the second network device, handover request acknowledgment information to the first network device. The handover request acknowledgment information includes ensembling indication information. The ensembling indication information indicates to the terminal device to perform model ensembling. Alternatively, the transceiver unit 1620 is further configured to send, by the second network device, ensembling indication information to the terminal device. The ensembling indication information indicates to the terminal device to perform model ensembling.

The transceiver unit 1620 is further configured to receive, by the second network device, AI configuration information from the third network device. The AI configuration information includes AI operation indication information and one or more of the following: a model parameter, a data type, or data processing type. The AI operation indication information includes an AI area identifier. The AI operation indication information indicates an AI operation corresponding to the terminal device and/or the second network device. The AI operation includes one or more of: model inference, model evaluation, model training, or data processing.

In a possible manner, the processing unit 1610 may be implemented by a processor, and the transceiver unit 1620 may be implemented by a transceiver. For examples of functions and beneficial effects of the processing unit 1610 and the transceiver unit 1620, refer to the methods shown in FIG. 8, FIG. 9, and FIG. 11 to FIG. 14. Details are not described herein again.

With reference to FIG. 17, some embodiments of this application further provide a communication apparatus 1700, configured to implement functions of the communication apparatus 1500 and the communication apparatus 1600 in the foregoing methods. The communication apparatus may be a terminal device or a network device, an apparatus in a terminal device or a network device, or an apparatus that can be used with a terminal device and a network device in a matching manner. The communication apparatus 1700 includes at least one processor 1710. The communication apparatus 1700 may further include a communication interface 1720.

The processor 1710 may perform functions performed by the processing unit 1510 in the communication apparatus 1500 or the processing unit 1610 in the communication apparatus 1600. The communication interface 1720 may be configured to perform functions performed by the transceiver unit 1520 in the communication apparatus 1500 or the transceiver unit 1620 in the communication apparatus 1600.

When the communication apparatus 1700 is configured to perform operations performed by the communication apparatus 1500, the processor 1710 is configured to: obtain, by a terminal device, a first model of a first network device, and perform model ensembling on the first model and a second model; and the communication interface 1720 is configured to: receive, by the terminal device, first model indication information from a second network device, send second model indication information to the second network device, send third model indication information to the first network device, send capability information to the first network device or the second network device, receive ensembling indication information from the second network device, and receive AI configuration information from a third network device.

When the communication apparatus 1700 is configured to perform operations performed by the communication apparatus 1600, the communication interface 1720 is configured to: send, by the second network device, first model indication information to the terminal device, receive second model indication information from the terminal device, send fourth model indication information to the first network device, send fifth model indication information to the third network device, receive handover request information from the first network device, receive capability information from the terminal device, send handover request acknowledgment information to the first network device, send ensembling indication information to the terminal device, and receive AI configuration information from the third network device; and the processor 1710 is configured to determine, based on the capability information, that the terminal device has a model ensembling capability.

The communication interface 1720 is further configured to perform other receiving or sending steps or operations performed by the communication apparatus 1500 and the communication apparatus 1600 in the foregoing method embodiments. The processor 1710 may be further configured to perform other corresponding steps or operations performed by the communication apparatus 1500 and the communication apparatus 1600 in the foregoing method embodiments other than receiving and sending. Details are not described herein again.

The communication apparatus 1700 may further include at least one memory 1730, configured to store program instructions and/or data. The memory 1730 is coupled to the processor 1710. Coupling in some embodiments of this application may be indirect coupling or a communication connection between apparatuses, units, or modules in an electrical form, a mechanical form, or another form, and is used for information exchange between the apparatuses, the units, or the modules. The processor 1720 may collaboratively operate with the memory 1730. The processor 1710 may execute a computer program or instructions stored in the memory 1730. In a possible implementation, at least one memory may be integrated with the processor. In another possible implementation, the memory 1730 is located outside the communication apparatus 1700.

A specific connection medium between the processor 1710, the communication interface 1720, and the memory 1730 is not limited in embodiments of this application. In some embodiments of this application, the memory 1730, the processor 1710, and the communication interface 1720 are connected to each other through a bus 1740 in FIG. 17. The bus is represented by using a bold line in FIG. 17. A connection manner between other components is merely an example for description, and is not limited thereto. The bus may be classified into an address bus, a data bus, a control bus, or the like. For ease of representation, only one thick line is used to represent the bus in FIG. 17, but this does not indicate that there is only one bus or only one type of bus.

In a possible implementation, the communication apparatus 1700 may be a chip system. In some embodiments of this application, the chip system may include a chip, or may include a chip and another discrete device.

In some embodiments of this application, the processor 1710 may be one or more central processing units (CPU). When the processor is one CPU, the CPU may be a single-core CPU, or may be a multi-core CPU. The processor may be a general-purpose processor, a digital signal processor, an application-specific integrated circuit, a field programmable gate array or another programmable logic device, a discrete gate or transistor logic device, or a discrete hardware component, and may implement or execute the methods, steps, and logical block diagrams disclosed in embodiments of this application. The general-purpose processor may be a microprocessor, any conventional processor, or the like. The steps of the methods disclosed with reference to embodiments of this application may be directly performed and completed by a hardware processor, or may be performed and completed by a combination of hardware and software modules in the processor.

In some embodiments of this application, the memory 1730 may include but is not limited to a nonvolatile memory, for example, a hard disk drive (HDD) or a solid-state drive (SSD), a random access memory (RAM), an erasable programmable read-only memory (EPROM), a read-only memory (ROM), a compact disc read-only memory (CD-ROM), or the like. The memory is any other medium that can carry or store expected program code in a form of an instruction or a data structure and that can be accessed by a computer, but is not limited thereto. The memory in some embodiments of this application may be alternatively a circuit or any other apparatus that can implement a storage function, and is configured to store a computer program or instructions and/or data.

An embodiment of this application further provides an apparatus 1800. As shown in FIG. 18, the apparatus 1800 may be configured to implement functions of the apparatus 1500 or the apparatus 1600. The apparatus 1800 may be a communication apparatus or a chip in a communication apparatus. The communication apparatus includes:
at least one input/output interface 1810 and a logic circuit 1820. The input/output interface 1810 may be an input/output circuit. The logic circuit 1820 may be a signal processor, a chip, or another integrated circuit that can implement the method in this application.

The logic circuit is coupled to the input/output interface. The at least one input/output interface 1810 is configured to input or output a signal or data, to perform corresponding procedures of the methods in FIG. 6 to FIG. 9 and FIG. 11 to FIG. 14.

When the communication apparatus is a chip used in a terminal, the chip in the terminal implements the functions of the terminal in the foregoing method embodiments. The chip in the terminal receives information from another module (for example, a radio frequency module or an antenna) in the terminal. The information is sent by another terminal or a network device to the terminal. Alternatively, the chip in the terminal outputs information to another module (for example, a radio frequency module or an antenna) in the terminal. The information is sent by the terminal to another terminal or a network device.

When the communication apparatus is a chip used in a network device, the chip in the network device implements functions of the network device in the foregoing method embodiments. The chip in the network device receives information from another module (for example, a radio frequency module or an antenna) in the network device. The information is sent by a terminal or another network device to the network device. Alternatively, the chip in the network device outputs information to another module (for example, a radio frequency module or an antenna) in the network device. The information is sent by the network device to a terminal or another network device.

An embodiment of this application further provides a computer-readable storage medium. The computer-readable storage medium stores a computer program or instructions. The computer program or the instructions is/are executed by a computer (for example, a processor), to implement some or all of the steps in any method performed by any apparatus in embodiments of this application.

An embodiment of this application further provides a computer program product including instructions. When the computer program product is run on a computer, some or all of the steps in any method performed by any apparatus in embodiments of this application are performed.

A person of ordinary skill in the art may be aware that, units, algorithms, and steps described in the examples described with reference to embodiments disclosed in this specification may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, reference may be made to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division. In actual implementation, another division manner may be used. For example, a plurality of units or components may be combined or integrated into another system, or some features may be ignored or may not be performed. In addition, the displayed or discussed mutual couplings or direct couplings or communication connections may be implemented by using some interfaces. The indirect couplings or communication connections between the apparatuses or units may be implemented in an electrical, mechanical, or another form.

The units described as separate parts may or may not be physically separate, and parts displayed as units may or may not be physical units, and may be at one location, or may be distributed on a plurality of network elements. Some or all of the units may be selected according to actual requirements to achieve the objectives of the solutions of embodiments.

In addition, functional units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or parts contributing to the conventional technologies, or some of the technical solutions, may be embodied in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a removable hard disk, a ROM, a RAM, a magnetic disk, or an optical disc.

The foregoing descriptions are merely some implementations of this application, and are not intended to limit the protection scope of this application. Any variation or replacement readily ascertained by a person skilled in the art within the technical scope disclosed in this application shall fall within the protection scope of this application.

What is claimed is:

1. A wireless communication method, comprising:
obtaining, by a terminal device, a first model of a first network device:
receiving, by the terminal device, first model indication information from a second network device, wherein the first model indication information indicates a second model of the second network device; and
sending, by the terminal device, second model indication information to the second network device, wherein the second model indication information indicates an ensemble model of the first model and the second model.

2. The method according to claim 1, further comprising: handing over the terminal device from the first network device to the second network device.

3. The method according to claim 1, wherein the second model indication information comprises a model parameter of the ensemble model.

4. The method according to claim 1, wherein the method further comprises:
sending, by the terminal device, third model indication information to the first network device, wherein the third model indication information indicates the ensemble model.

5. The method according to claim 1, wherein before the receiving, by the terminal device, first model indication information from a second network device, the method further comprises:
sending, by the terminal device, capability information to the first network device or the second network device, wherein the capability information comprises computility and/or storage space of the terminal device.

6. The method according to claim 5, wherein the method further comprises:
receiving, by the terminal device, ensembling indication information from the second network device, wherein the ensembling indication information indicates to the terminal device to perform model ensembling, and
the ensemble model is obtained by the terminal device by performing model ensembling on the first model and the second model based on the ensembling indication information.

7. A communication apparatus, comprising at least one processor, and one or more memories coupled to the at least one processor and storing programming instructions for execution by the at least one processor to perform operations comprising:
obtaining a first model of a first network device,
receiving first model indication information from a second network device, wherein the first model indication information indicates a second model of the second network device; and
sending second model indication information to the second network device, wherein the second model indication information indicates an ensemble model of the first model and the second model.

8. The communication apparatus according to claim 7, wherein the operations further comprise: performing a handover from the first network device to the second network device.

9. The communication apparatus according to claim 7, wherein the second model indication information comprises a model parameter of the ensemble model.

10. The communication apparatus according to claim 7, wherein the operations further comprise:
sending third model indication information to the first network device, wherein the third model indication information indicates the ensemble model.

11. The communication apparatus according to claim 7, wherein before the receiving first model indication information from a second network device, the operations further comprise:
sending capability information to the first network device or the second network device, wherein the capability information comprises computility and/or storage space of a terminal device.

12. The communication apparatus according to claim 11, wherein the operations further comprise:
receiving ensembling indication information from the second network device, wherein the ensembling indication information indicates to perform model ensembling, and
the ensemble model is obtained by the communication apparatus by performing model ensembling on the first model and the second model based on the ensembling indication information.

13. The communication apparatus according to claim 7, wherein the first model indication information further comprises a model ensembling parameter of the second network device.

14. A communication apparatus comprising at least one processor, and one or more memories coupled to the at least one processor and storing programming instructions for execution by the at least one processor to perform operations comprising:
sending first model indication information to a terminal device, wherein the first model indication information indicates a second model of a second network device; and
receiving second model indication information from the terminal device, wherein the second model indication information indicates an ensemble model of a first model and the second model, and the first model is a model that is of a first network device and that is obtained by the terminal device.

15. The communication apparatus according to claim 14, wherein the second network device is a target network device to which the terminal device is handed over.

16. The communication apparatus according to claim 14, wherein the second model indication information comprises a model parameter of the ensemble model.

17. The communication apparatus according to claim 14, wherein the operations further comprise:
sending fourth model indication information to the first network device, wherein the fourth model indication information indicates the ensemble model; or
sending fifth model indication information to a third network device, wherein the fifth model indication information indicates to the third network device to send the ensemble model to the first network device.

18. The communication apparatus according to claim 14, wherein before the sending first model indication information to a terminal device, the operations further comprise:
receiving handover request information from the first network device, wherein the handover request information comprises capability information; or
receiving the capability information from the terminal device, wherein
the capability information comprises computility and/or storage space of the terminal device.

19. The communication apparatus according to claim 18, wherein the operations further comprise:
determining, based on the capability information, that the terminal device has a model ensembling capability; and
sending handover request acknowledgment information to the first network device, wherein the handover request acknowledgment information comprises ensembling indication information, and the ensembling indication information indicates to the terminal device to perform model ensembling, or
sending ensembling indication information to the terminal device, wherein the ensembling indication information indicates to the terminal device to perform model ensembling, and
the ensemble model is obtained by the terminal device by performing model ensembling on the first model and the second model based on the ensembling indication information.

20. The communication apparatus according to claim 14, wherein the first model indication information further comprises a model ensembling parameter of the second network device.
